(19) United States
(12) Patent Application Publication
(10) Pub. No.: US 2008/0219377 A1
(43) Pub. Date: Sep. 11, 2008

(54) Transmitter crosstalk cancellation in multi-standard wireless transceivers

(75) Inventor: John Nisbet, Nepean (CA)

Correspondence Address: FREEDMAN & ASSOCIATES, 117 CENTREPOINTE DRIVE, SUITE 350, NEPEAN, ONTARIO, K2G 5X3, CA

(73) Assignee: SiGe Semiconductor Inc., Ottawa (CA)

(21) Appl. No.: 11/714,198

(22) Filed: Mar. 6, 2007

(51) Int. Cl. H04B 15/00

(52) U.S. Cl. 375/296; 375/346

(57) ABSTRACT

A method of suppressing interference from a transmitter operating to a first standard to a local receiver operating to a second standard is provided. Such interference being increasingly common as a result of the deployment of multiple wireless transceivers within electronic devices supporting multiple international standards, such as WiFi and WiMAX. Advantageously, the invention presents a means of actively cancelling interference both from transmitters operating within the same frequency range as defined by the standard as well as those operating in different frequency ranges. The active cancellation accordingly allows improved performance for systems with very low received signal powers, such as GPS, in addition to wireless data communications standards. An exemplary embodiment providing active cancellation through delaying a portion of the transmitted signal and adjusting both the amplitude and phase by means of polar modulation prior to summing this signal with the detected signal to provide a receive signal within which the transmit signal is nulled.

### FIELD OF THE INVENTION

The invention relates to cancelling crosstalk within multi-standard wireless transceivers, and more particularly to integrated circuit implementations.

### BACKGROUND OF THE INVENTION

In recent years, the use of wireless and RF technology has increased dramatically in portable and hand-held units, where such units are deployed by a variety of individuals from soldiers on the battlefield to a mother searching for her daughter's friend's house. The uses of wireless technology are widespread, increasing, and include but are not limited to telephony, Internet e-mail, Internet web browsers, global positioning, photography, and in-store navigation. Additionally, devices incorporating wireless technology have expanded to include not only cellular telephones, but Personal Data Analyzers (PDAs), laptop computers, palmtop computers, gaming consoles, printers, telephone headsets, portable music players, point of sale terminals, global positioning systems, inventory control systems, and even vending machines.

The wireless infrastructure for these devices can support data, voice and other services on multiple standards, examples include but are not limited to:
WiFi [ANSI/IEEE Standard 802.11, “Wireless LAN Medium Access Control (MAC) and Physical Layer (PHY) Specifications,” Reaffirmed 2003];
WiMAX [IEEE Standard 802.16, “Air Interface for fixed Broadband Wireless Access Systems,” 2004];
Bluetooth [IEEE Standard 802.15.1, “Wireless Medium Access Control (MAC) and Physical Layer (PHY) Specifications for Wireless Personal Area Networks (WPANS),” Reaffirmed 2005]; and
ZigBee [IEEE Standard 802.15.4, “Wireless Medium Access Control (MAC) and Physical Layer (PHY) Specifications for Low-Rate Wireless Personal Area Networks (LR-WPANs),” 2003].

WiFi (WLAN) communication has enjoyed overwhelming consumer acceptance worldwide, generally as specified in IEEE 802.11a (operating in the frequency range of 4900-5825 MHz) or IEEE 802.11b and IEEE 802.11g specifications (operating in the range 2400-2485 MHz). These standards seem destined to survive and thrive in the future, for example with the IEEE 802.11n MIMO physical layer. The 802.11 value proposition is the provision of low cost, moderate data communication/transport rates and simple network function.

WiMAX (WMAN) communication is also preparing to deploy massively worldwide, especially as IEEE 802.16e (operating at two frequency ranges, the first being 2300-2690 MHz, and the second of 3300-3800 MHz). The IEEE 802.16e value proposition is the provision of moderate cost and high data communication/transport rates at high quality of service, which requires higher system performance and complexity.

As a result, it is highly likely that many applications and devices will need to support both WiMAX and WiFi services, with the two units typically being co-located a few centimeters apart. As such a potential difficulty arises if the IEEE 802.16e WiMAX transceiver tries to operate in the first, lower frequency band of 2300-2690 MHz, and is co-located or close to an IEEE 802.11b/g WiFi transceiver. Although the IEEE 802.16e spectrum is segmented, into two bands, the lower 2300-2397.5 MHz and upper 2496-2690 MHz, these straddle the IEEE 802.11b/g band of 2400-2485 MHz closely, giving negligible guard bands of unused spectrum between the two services to prevent mutual interference.

Furthermore, although IEEE 802.16e transceivers employ transmit/receive duplexing this is synchronized “globally” throughout the area served by each base station, the transmit/receive duplexing of IEEE 802.11b/g transceivers is negotiated locally with each independent network access point. As there may be many IEEE 802.11b/g network access points within the transmission zone of one IEEE 802.16e base station, and the two systems operate completely independently. The co-located units will therefore see a varying combination of IEEE 802.11b/g or IEEE 802.16e transmitters/receivers at any given time.

At present, there are no aspects of these IEEE 802.11b/g and IEEE 802.16e standards that address the collocation and interaction/interference of such collocated systems. Considering prior art approaches to removing interference of multiple co-located transceivers, then solutions would appear to be time separation, frequency separation, filtering, and passive interference. Considering these in order:

Time Separation: An exemplary embodiment of time separation would be to force IEEE 802.11 devices not to transmit whilst an IEEE 802.16 device is receiving, or vice-versa. However, this requires the Media Access Control (MAC) and higher layers of the WiFi and WiMAX systems to interact, which is not facilitated within existing systems, and would fundamentally reduce aggregate throughput in both systems;

Frequency Separation: An exemplary embodiment of frequency separation would be to provide “bar” operation, and thereby clear, frequency bands within both IEEE 802.11 and IEEE 802.16 systems near the band boundaries. However, frequency separation wastes spectrum in one or both systems and reduces aggregate throughput;

Filtering: Filtering and/or duplexing the IEEE 802.11 and IEEE 802.16 systems away from each other, without impacting aggregate throughput, requiring MAC or higher interactions etc. The limited clearance between the frequency bands of the two systems requires impractically high-order filters. For example, near 2400 MHz the last WiMAX channel is 2397.5 MHZ and the first WiFi channel is 2412 MHz. For an attenuation of AdB in the stop band of the filter, with a stop band frequency of [symbol] (s), and a passband frequency of [symbol] (p) then the order, η, of the required filter is given by:

η=Λ/{20*log[ [symbol] (s)/ [symbol] (p)]} (1)

For Λ=30, [symbol] (s)=2412 MHz, and [symbol] (p)=2397.5 MHz, the required filter order η is 573! Such filters, even if feasible could not be integrated into the low cost semiconductor circuits being provided for the WiFi and WiMAX transceivers, increasing costs, degrading performance, increasing footprint and packaging complexity etc. Further, such filtering cannot filter out IEEE 802.11 (WiFi) transmitter leakage because it is in-band for the IEEE 802.16 (WiMAX) receiver;

Passive Interference: Originating from radar infrastructure, the approach introduces a predetermined portion of the transmitted signal from an antenna into the receive path of a collocated second antenna. Whilst, such an approach does not waste spectrum in one or both systems, nor does it reduce aggregate throughput, such approaches within the prior art do not support the varying interaction between antennae as typically occurring in today's mobile devices with multiple local transmitters interacting with a receiver, such as a WiMAX receiver, which is collocated or monolithically integrated with a transmitter of another system, such as WiFi transmitter.

Finally, an alternative approach has been considered of Localized Device Control. As noted supra the MAC and higher layers of the WiFi and WiMAX systems do not interact at the overall network level. However, it is reasonable to assume that when these two transceivers are within a single device, such as a laptop computer, that the IEEE 801.11b/g and IEEE 801.16e modems are mutually aware as they are probably controlled from the same PCI bus. Hence, a “trick” could be to have either the IEEE 801.11b/g or IEEE 801.16e modems take priority and force the other “off the air” temporarily; essentially an extreme variant of time separation. For example, the IEEE 801.16e modem could “pose” as the closest network access point, force the IEEE 801.11b/g modem to associate with it on channel 6 (or channel 7 in European installations) and then unassociated after IEEE 801.16e reception is complete. Such association being a logical connection between the mobile station (MS) and access point (AP) which is formally defined within the IEEE 802.11 standard, such associations normally occurring at power on of the MS or when it re-discovers an AP after temporarily losing touch.

The difficulty with this is that it wastes most, or all, of the IEEE 802.11b/g band during the IEEE 802.16e operation. If the WiFi service is forced off the air simply because WiMAX is being used nearby, the bandwidth is available from the point of view of the WiFi AP, but cannot be used by the WiFi MS because of local conditions. Further it imposes additional transmit/receive protocol overhead and complexities into the communications. IEEE 802.11 is designed with a fairly simple arrangement whereby the MS and AP can agree on who will talk or listen at what times, and what information is transmitted in what order. It is not designed to synchronize with any other system and these complexities will result in association and throughput rates being significantly worse than normal design values.

As such, none of the prior art approaches provide a solution that does not waste spectrum in one or both systems, nor reduces aggregate throughput. Further, such prior art approaches are particularly adapted to network environments wherein IEEE 802.11b/g and IEEE 802.16e modems are relatively stationary allowing protocols to be established and utilized. However, today's wireless environments are not stationary for significant periods of time, and such networks are projected to become even less so as ad-hoc networking architectures become more common due to the elimination of significant network planning requirements and eliminating significant infra-structure costs. As such portable devices with multi-standard modems (such as IEEE 802.11b/g and IEEE 802.16e) will continually adjust to achieve network access and provide active leakage from one modem to another as the local environment changes.

Furthermore the prior art approaches do not support the emergence of many consumer orientated electronic devices that operate with collocated or spatially close transmitters on multiple standards. Additionally, requirements for an active interference cancellation scheme within such high volume, low cost electronic devices include adapting to changes in the wireless environment, such as the addition of a new transceiver or a change in the local environment of the electronic device, and compatibility with the integrated circuit chip set providing the transceiver functionality. Whilst many electronic devices might be supplied already supporting multiple standards, the “plug-and-play” nature of many adapters and devices allows users to rapidly add additional wireless capabilities to their electronic devices.

It would be further advantageous if the active interference cancellation approach utilized low power control and adaptation techniques to enhance battery lifetime for mobile devices supporting the collocated systems, was dynamically adaptive to support the switching of one systems transmitter/receiver pair whilst another system is active.

### SUMMARY OF THE INVENTION

In accordance with the invention there is provided a method, comprising:
providing at least a receiver for receiving signals according to a first wireless standard, the receiver comprising at least one band-limiting filter of a plurality of band-limiting filters;
providing at least a transmitter for transmitting a transmit signal according to a second other wireless standard; providing a first signal for transmission from the transmitter;
generating a first cancellation signal, the first cancellation signal being at least a portion of the transmit signal and having at least one of a predetermined time delay, predetermined amplitude relationship, and predetermined phase relationship with respect to the transmit signal;
providing the first cancellation signal by other than the transmitter, the first cancellation signal for combining with a received signal received at the receiver; and
generating a control signal, the control signal for controlling an aspect of the generation of the first cancellation signal and being generated in dependence upon a measure of the received signal power after filtering thereof by the band-limiting filters.

In accordance with another embodiment of the invention there is provided a circuit, comprising:
at least a receiver for receiving signals according to a first wireless standard, the receiver comprising at least one band-limiting filter of a plurality of band-limiting filters;
at least a transmitter for transmitting a transmit signal according to a second other wireless standard;
a first cancellation signal generating circuit for generating a first cancellation signal in response to a control signal, the first cancellation signal being at least a portion of the transmit signal and having at least one of a predetermined time delay, predetermined amplitude relationship, and predetermined phase relationship with respect to the transmit signal;
a transmission path for providing the first cancellation signal by other than the transmitter, the first cancellation signal for combining with a received signal received at the receiver; and
a control signal output port for providing the control signal for controlling an aspect of the generation of the first cancellation signal and being generated in dependence upon a measure of the received signal power after filtering thereof by the band-limiting filters.

In accordance with another embodiment of the invention there is provided a computer readable medium having stored therein data according to a predetermined computing device format, and upon execution of the data by a suitable computing device a method of improving a receiver is provided, comprising:
providing at least a receiver for receiving signals according to a first wireless standard, the receiver comprising at least one band-limiting filter of a plurality of band-limiting filters;
providing at least a transmitter for transmitting a transmit signal according to a second other wireless standard;
providing a first signal for transmission from the transmitter;
generating a first cancellation signal, the first cancellation signal being at least a portion of the transmit signal and having at least one of a predetermined time delay, predetermined amplitude relationship, and predetermined phase relationship with respect to the transmit signal;
providing the first cancellation signal by other than the transmitter, the first cancellation signal for combining with a received signal received at the receiver; and
generating a control signal, the control signal for controlling an aspect of the generation of the first cancellation signal and being generated in dependence upon a measure of the received signal power after the band limiting filters.

In accordance with another embodiment of the invention there is provided a computer readable medium having stored therein data according to a predetermined computing device format, and upon execution of the data by a suitable computing device a method of improving a receiver is provided, comprising:
determining a state of the transmitter;
generating the first cancellation signal according to a first state of the transmitter and generating other than the first cancellation signal in a second state of the transmitter.

In accordance with another embodiment of the invention there is provided a computer readable medium having stored therein data according to a predetermined computing device format, and upon execution of the data by a suitable computing device a circuit for improving a receiver is provided, comprising:
at least a receiver for receiving signals according to a first wireless standard, the receiver comprising at least one band-limiting filter of a plurality of band-limiting filters;
at least a transmitter for transmitting a transmit signal according to a second other wireless standard;
a first cancellation signal generating circuit for generating a first cancellation signal in response to a control signal, the first cancellation signal being at least a portion of the transmit signal and having at least one of a predetermined time delay, predetermined amplitude relationship, and predetermined phase relationship with respect to the transmit signal;
a transmission path for providing the first cancellation signal by other than the transmitter, the first cancellation signal for combining with a received signal received at the receiver; and
a control signal output port for providing the control signal for controlling an aspect of the generation of the first cancellation signal and being generated in dependence upon a measure of the received signal power after filtering thereof by the band-limiting filters.

In accordance with another embodiment of the invention there is provided a computer readable medium having stored therein data according to a predetermined computing device format, and upon execution of the data by a suitable computing device a circuit for improving a receiver is provided, wherein:
the first cancellation signal generating circuit comprises a transmitter enable port for receiving a transmitter enable signal from the transmitter, the transmitter enable signal determining a state of the transmitter, and
the first cancellation signal generating circuit generates the first cancellation signal according to a first state of the transmitter and generates other than the first cancellation signal in a second state of the transmitter.

### BRIEF DESCRIPTION OF THE DRAWINGS

Exemplary embodiments of the invention will now be described in conjunction with the following drawings, in which:

FIG. 1 illustrates an exemplary scenario for collocated mobile communications systems within a device.

FIG. 2 illustrates a prior art interference cancellation scheme for a duplex transmission system with a single antenna.

FIG. 3 illustrates a second prior art interference cancellation scheme for multiple transmission systems with multiple antennae.

FIG. 4 illustrates an exemplary first embodiment of the invention for active cancellation of transmitter leakage from one wireless system to another.

FIG. 5 illustrates an exemplary spectrum of a first transmission signal from a first system operating within the same frequency band as a second signal for a second collocated system.

FIG. 6A illustrates an exemplary spectrum of a cancellation null according to an exemplary embodiment of the invention positioned to align with a first transmission signal from a first system operating within the same frequency band as a second signal for a second collocated system.

FIG. 6B illustrates an exemplary spectrum of a first transmission signal from a first system operating within the same frequency band as a second signal for a second collocated system wherein a cancellation null according to an embodiment of the invention is aligned with the second signal.

FIG. 7 illustrates an exemplary two-dimensional binary search for the optimum coefficients of the coefficient engine driving a Cartesian modulator providing the amplitude and phase adjustment of the transmitter signal applied to cancel the transmitter leakage.

FIG. 8A illustrates an exemplary embodiment of the invention wherein three bidirectional transceivers are actively cancelled for transmitter leakage.

FIG. 8B illustrates the interconnection of the coordinate engines of the three cancellation circuits to the polar modulators generating the cancellation signals according to the exemplary embodiment of FIG. 8A.

FIG. 9 illustrates an exemplary flow diagram for calibrating an active cancellation circuit according to an embodiment of the invention.

FIG. 10 illustrates an exemplary embodiment of the invention wherein multiple cancellation elements are provided for actively cancelling the transmitter leakage.

FIG. 11A illustrates an exemplary embodiment for actively cancelling the leakage between a WiMAX transmitter and a GPS receiver.

FIG. 11B illustrates the power spectral density spectrum for a system operating according to the embodiment presented in respect of FIG. 11A.

### DETAILED DESCRIPTION OF EMBODIMENTS OF THE INVENTION

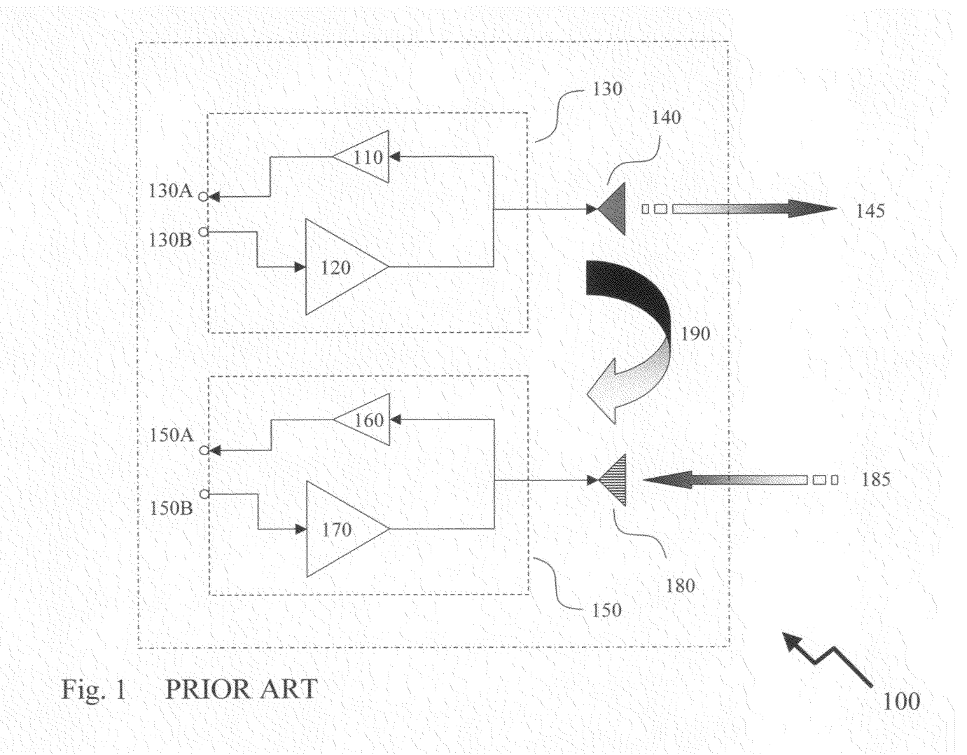

FIG. 1 illustrates an exemplary scenario for collocated mobile communications systems via WiFi transceiver 130 and WiMAX transceiver 150 within a multi-standard device 100.

As shown the WiFi transceiver 130 comprises a WiFi antenna 140, for receiving and transmitting data over the WiFi carrier 145 according to an IEEE 802.11b or an IEEE 802.11g standard operating in the range 2400-2485 MHz. Shown for the WiFi transceiver 130 are transmit signal input port 130B, which receives the data for transmission encoded onto the appropriate channel within the WiFi frequency range, and is coupled to the WiFi power amplifier 120 for boosting and feeding forward to the WiFi antenna 140. The WiFi antenna 140 is also coupled to a WiFi receiver amplifier 110, which receives WiFi signals from the WiFi antenna 140, boosts them with low noise and high gain due to the low received power and couples this signal to the WiFi receiver port 130A.

Also the WiMAX transceiver 150 is electrically coupled to a WiMAX antenna 180, for receiving and transmitting data over the WiMAX carrier 185, IEEE 802.16e, operating at the lower of the two frequency ranges, 2300-2690 MHz. In an alternative embodiment the IEEE 802.16e carrier operates on the second upper frequency range of 3300-3800 MHz. Shown for the WiMAX transceiver 150 are transmit signal input port 150B, which receives the data for transmission encoded onto the appropriate channel within the WiMAX frequency range, and is coupled to the WiMAX power amplifier 170 for boosting and provision to the WiFi antenna 180. The WiFi antenna 180 is also coupled to a WiMAX receiver amplifier 160, which receives WiMAX signals from the WiMAX antenna 180, boosts them with low noise and high gain due to the low received power and couples this signal to the WiMAX receiver port 150A.

If the WiFi transceiver 130 and WiMAX transceiver 150 were remote from one another then leakage from the WiFi antenna 140 into the WiMAX antenna 180 does not typically present an issue, as the power levels are negligible. However, when the WiFi transceiver 130 and WiMAX transceiver 150 are within a multi-standard device 100, the spacing between antennae is often small, on the order of millimeters. Further, placement of the multi-standard device 100 increases this leakage, for example placement of the multi-standard device on a table surface, close to a users head, and next to a window. Each of these and other common placements results in dynamic adjustment in the leakage from one antenna to another.

A typical implementation of WiFi transceiver 130 and WiMAX transceiver 150 within a multi-standard device 100 is such that the WiFi transceiver 130 operates at +18 dBm according to the IEEE 801.11b/g standard, and that the WiFi antenna 140 and WiMAX antenna 180 are designed as small, cheap, omni-directional antennas that have very little directional or frequency isolation between them, and hence a typical isolation of about 20-25 dB is expected at 2500 MHz. Since both antennas are often fixed with respect to each other and with respect to electrically significant metal and dielectric masses nearby, the WiFi transceiver 130 presents a signal of approximately −2 dBm to the WiMAX transceiver 150, whereas the WiMAX receiver 150 operates with a signal as low as −70 dBm according to the IEEE 802.16e specification.

Not only might the WiFi (IEEE 802.11b/g) signal saturate or even potentially overload the WiMAX receiver amplifier 160 but other channel leakages, that are potentially at −30 dBc and −50 dBc, respectively according to IEEE 802.11b, could appear directly in-band for the WiMAX (IEEE 802.16e) signals in some scenarios. As such, these other channel leakages, at −32 dBm and −52 dBm respectively would present an intractable instantaneous dynamic range problem. Such a dynamic range problem is a situation where a wanted signal at very low level is received simultaneously with an interfering signal at much higher level, the dynamic range being the difference between the very low receiver noise floor required to receive the wanted signal and simultaneously the very high receiver distortion threshold required to prevent the interfering signal from clipping the receiver. An intractable dynamic range problem is one in which the interferer is at or near a same frequency as the wanted signal, and therefore cannot be filtered out.

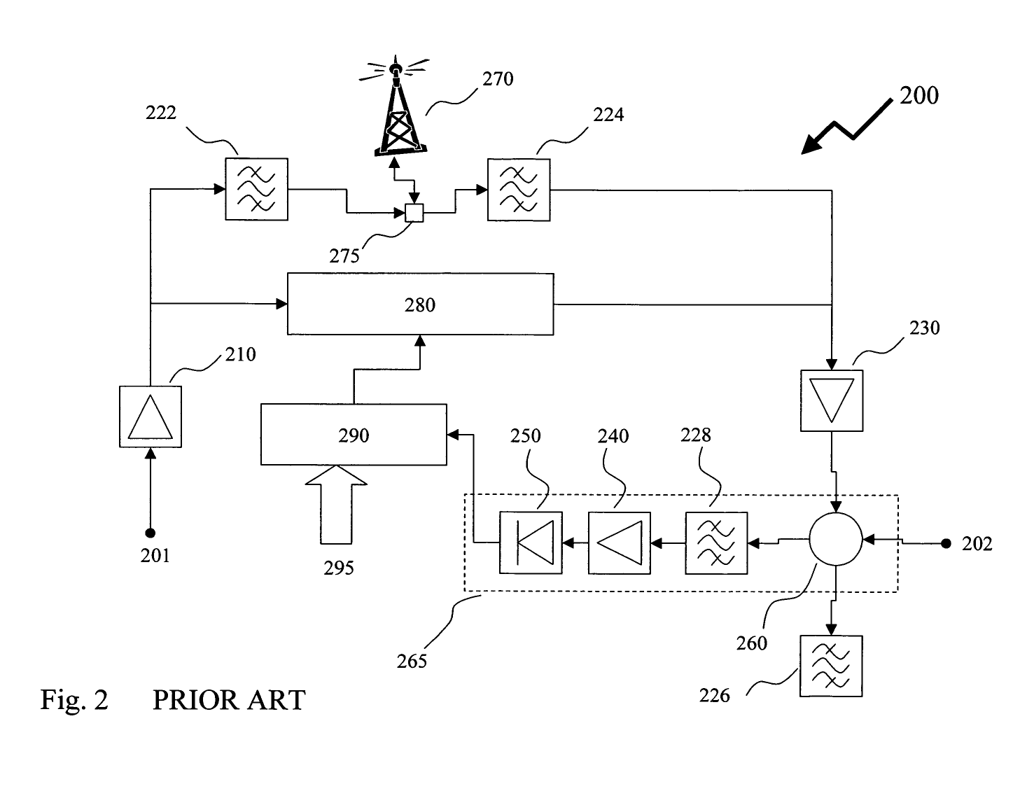

FIG. 2 illustrates a prior art interference cancellation scheme for a duplex transceiver 200 employing a single antenna. 270. The duplex transceiver 200 is implemented for the UMTS standard supporting a full duplex mode unlike the GSM standard. In the UMTS full duplex mode, a chronological overlap between the transmission and reception modes of operation is permitted during operation. A signal for transmission is applied to transmitter port 201 from which it is electrically coupled to the transmitter output power amplifier stage 210. The output signal from the transmitter output power amplifier stage 210 is coupled via a transmission band-transmitting filter 222 and duplexer 275 to the antenna 270 for transmission. A pre-determined portion of the output power of the transmitter output power amplifier stage 210 is coupled to compensation element 280.

A receive signal coupled from the antenna 270 is then coupled via the duplexer 275 to the reception band transmission filter 224. At this point the predetermined portion of the output power of the transmitter output power amplifier stage 210 is applied along with the receive signal from the reception band transmission filter 224 to the reception pre-amplifier 230. The output signal of the reception pre-amplifier 230 is then applied to mixer 260. The reference mixing signal applied to the mixer 260 is coupled from the mixer input port 202. A first output signal of the mixer 260, which is part of a second receiver 265, is then electrically coupled to a simple bandpass filter 226 for subsequent processing and recovery of the encoded data. If we consider the mixing reference signal applied to the mixer port 202 to be [symbol] (vco) and the received signal from the reception pre-amplifier 230 to be [symbol] (dup) then the signal provided from the simple bandpass filter 226 is given by:

[symbol]

(itrx)± [symbol] (rx)± [symbol] (vco). (2)

A second output signal of the mixer 260 is then coupled to the bandpass filter 228 of the second receiver 265 which provides a signal given by:

[symbol]

(iftx)=± [symbol] (dup)± [symbol] (vco). (3)

This signal is then coupled to the second receiver amplifier 240 and a detector 250. The output signal of the detector 250 is an amplitude of the receive signal as measured by the narrowband detection circuit implemented within the second receiver 265. This amplitude of the receive signal is applied to a controller unit 290 which provides control signaling to compensation element 280. Additional control settings are provided to control unit 290 from a control bus port 295.

In operation, the prior art circuit provides an adaptive control based on a voltage measurement at the receiver antenna 270, the compensation element 280 adjusting the phase and amplitude of the transmitted signal in such a way that this measured voltage is minimized. As such the prior art relies upon a predetermined temporal relationship between the “leakage” as a result of contact or close proximity of the antenna to conductive objects or the human body. As such the prior art does not consider any variations within the temporal aspects of the leakage or that leakage causing degradation of reception is other than from the duplex transceiver 20 itself.

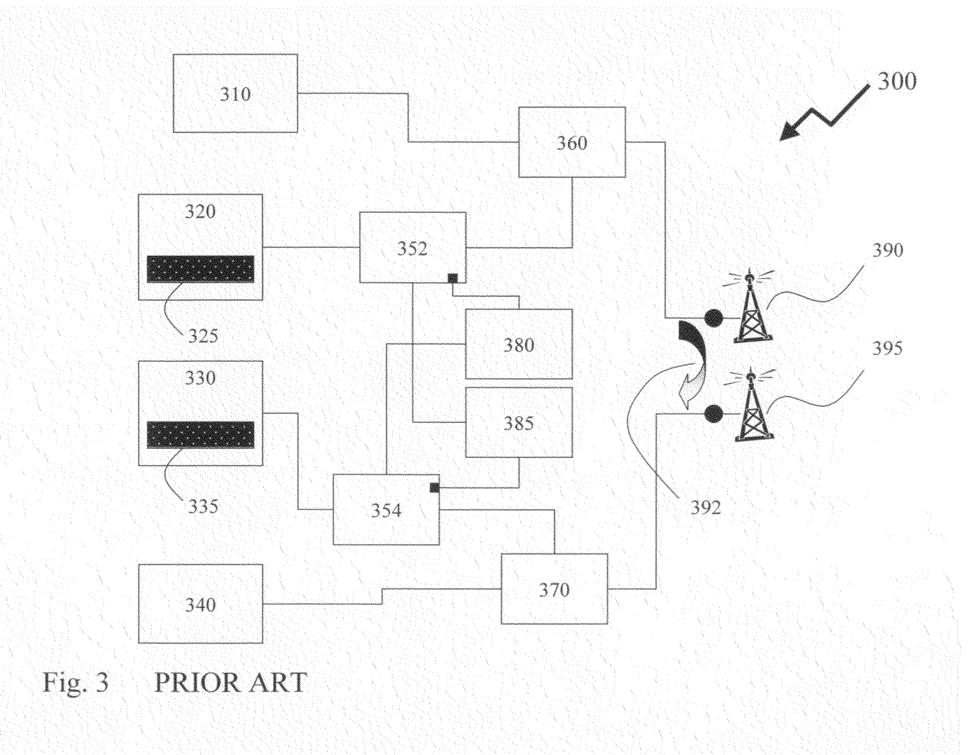

FIG. 3 illustrates a second prior art passive interference cancellation scheme for multiple transmission systems within a multi-standard device 300. As shown the multi-standard device 300 has a first antenna 390 and second antenna 395, which have a leakage path 392 with predetermined attenuation therebetween. Considering firstly the first antenna 390 this is electrically coupled to a first duplexer 360. The first duplexer 360 being electrically coupled to a first transmitter circuit 310, such as a GSM service operating on the 850 MHz or 900 MHz frequency bands, and a first coupler 352 which is electrically coupled to a second transmitter circuit 320, such as a Bluetooth™ device which incorporates a Bluetooth™ transceiver 325.

The first coupler 352 provides an output signal to a first phase shifter 380, being a portion of the output signal from the second transmitter circuit 320, and has a second input port coupled to a second phase shifter 385, which is electrically connected to a second coupler 354, providing a portion of the output signal of a third transmitter circuit 330. In an embodiment the third transmitter circuit comprises an IEEE 802.11a transceiver 335 operating at 5300 MHz. The second, and main output signal, of the second coupler 354 is fed forward to a second duplexer 370, which is electrically coupled to the second antenna 395. The other input port of the second duplexer 370 is coupled to fourth transmitter circuit 340, such as a GSM service on the 1800 MHz or 1900 MHz frequency bands.

Circuits within the multi-standard device 300 provide a feed forward portion of each of the second transmitter circuit 320 and third transmitter circuit 330 to each of the other of the second transmitter circuit 320 and third transmitter circuit 330, respectively, via the first phase shifter 380 and second phase shifter 385, respectively. In this manner, the Bluetooth™ transceiver 325 and IEEE 802.11b transceiver 335 are presented with phase shifted and fixed attenuation replicas of the other of the Bluetooth™ transceiver 325 and IEEE 802.11b transceiver 335, respectively. As such they are each provided with a passive interference cancellation scheme.

It would be evident to one skilled in the art that the prior art circuit has a predetermined amplitude weighting, from the fixed first and second couplers 352 and 354 determined from the predetermined attenuation 392, and variable phase relationship provided by the first and second phase shifters 380 and 385 in providing the passive interference cancellation. As such the passive cancellation cannot compensate for variations in the leakage between the first antenna 390 and second antenna 395.

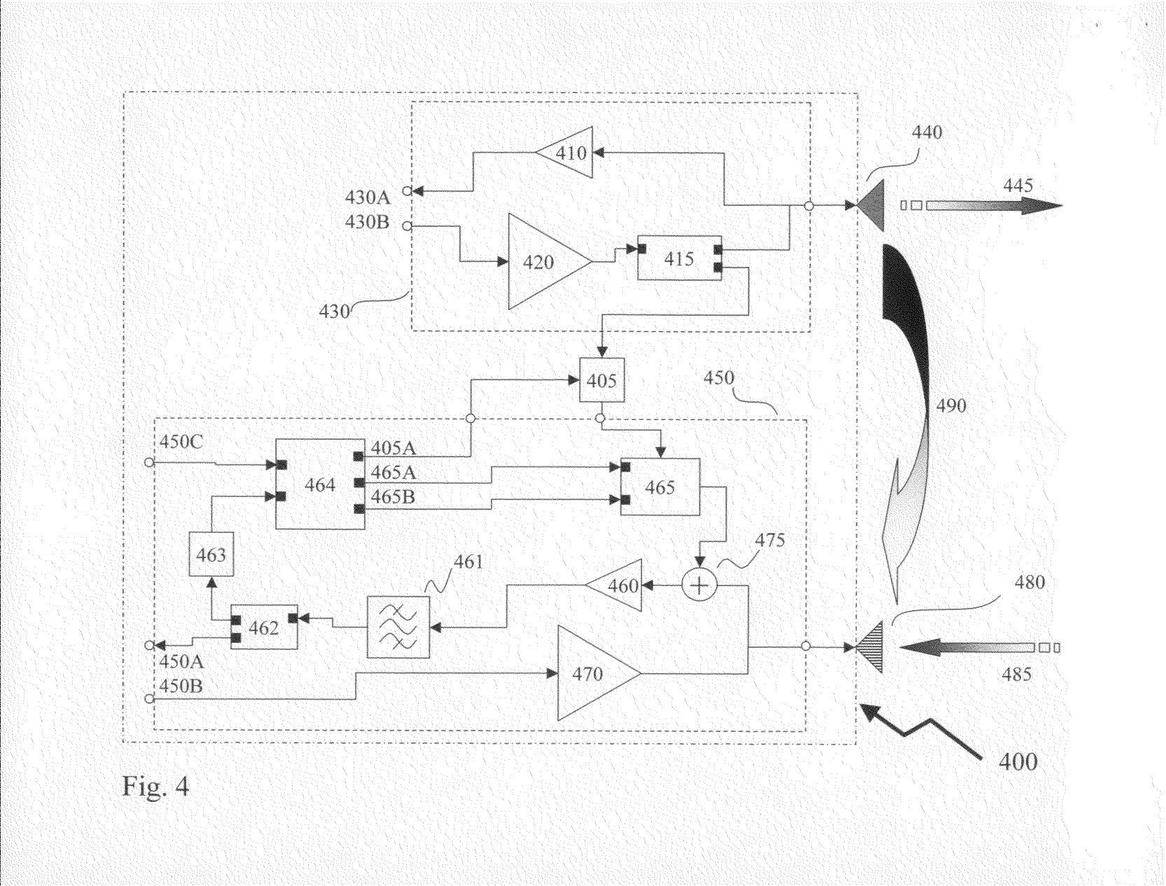

FIG. 4 illustrates a first embodiment of the invention for collocated mobile communications systems via WiFi transceiver 430 and WiMAX transceiver 450 within an active cancellation multi-standard device 400. As shown the WiFi transceiver 430 comprises a WiFi antenna 440, for receiving and transmitting data over the WiFi carrier 445 operating according to an IEEE 802.11b or an IEEE 802.11g standard within the range 2400-2485 MHz. Shown for the WiFi transceiver 430 are transmit signal input port 430B, which receives data for transmission encoded onto the appropriate channel within the WiFi frequency range, and is coupled to the WiFi power amplifier 420 for boosting and feeding forward to the WiFi antenna 440. Electrically disposed between the WiFi power amplifier 420 and WiFi antenna 440 is a coupler 415. The WiFi antenna 440 is also coupled to a WiFi receiver amplifier 410, which receives WiFi signals from the WiFi antenna 440, boosts them with low noise and high gain due to the low received power and couples this signal to the WiFi receiver port 430A.

Also the WiMAX transceiver 450 comprises a WiMAX antenna 480 for receiving and transmitting data over the WiMAX carrier 485 operating according to IEEE 802.16e at a lower of the two frequency ranges, 2300-2690 MHz. In an alternative embodiment the IEEE 802.16e operates on the second upper frequency range of 3300-3800 MHz. Shown for the WiMAX transceiver 450 are transmit signal input port 450B for receiving the data for transmission encoded onto the appropriate channel within the WiMAX frequency range coupled to the WiMAX power amplifier 470 for providing a signal thereto for boosting thereof and feeding the boosted signal forward to the WiMAX antenna 480. The WiMAX antenna 480 is also coupled to a WiMAX receiver amplifier 460 for receiving WiMAX signals from the WiMAX antenna 480, boosting them with low noise and high gain and coupling the boosted signal to the WiMAX receiver port 450A via band limiting filter 461 and Rx tap coupler 462 The second port of the Rx tap coupler couples a predetermined portion of the Rx signal after the band limiting filter 461 to the Rx power detector 463. Disposed within the electrical connection between the WiFi antenna 480 and WiMAX receiver amplifier 460 is a summation coupler 475.

The second output port of the coupler 415 is electrically coupled to delay circuit 405, the output port of which is electrically coupled to a polar modulator 465. Control of the delay circuit 405 is provided from the coefficient engine 464 at its delay control port 405A. Similarly control of the polar modulator 465 is provided from the coefficient engine 464 by two control signals, the first applied from the amplitude control port 465A and second from the phase control port 465B. The output port of the polar modulator 465 is coupled to the other input port of the summation coupler 475. The coefficient engine 464 receives two input signals from which its operation is determined. The first of these is the Tx Enable signal, which is applied at port 450C, being “HIGH” when the transmitter portion of the WiFi transceiver 430 is active, and “LOW” when dormant. The second is the output of the Rx power detector 463, which provides a measure of the power within the Rx channel of the WiMAX transceiver 450.

The polar modulator 465 provides modulation of a signal provided from the delay circuit 405 in a manner analogous to quadrature modulation but relying on polar co-ordinates, r (amplitude) and Θ (phase). Whereas quadrature modulators require a linear RF power amplifier, creating a design conflict between improving power efficiency or maintaining amplifier linearity, this is not a limitation within polar modulation, which allows highly non-linear amplifier architectures to be employed with high power efficiency. Such amplifiers are useful as polar modulation operates with an input signal of the amplifier of “constant envelope”, i.e. containing no amplitude variations. Hence, amplitude control is achieved by directly controlling the gain of the power amplifier, which is not undertaken in amplitude modulation wherein the amplifier is operated at fixed gain.

In a polar modulation system, the power amplifier input signal varies only in phase. Amplitude modulation is then accomplished by directly controlling the gain of the power amplifier. Thus a polar modulator allows the use of highly non-linear power amplifier architectures such as Class E and Class F, these being highly efficient switching power amplifiers.

In operation, an active cancellation multi-standard device 400 operates as follows: the coupler 415 within the WiFi transceiver 430 samples the WiFi transmission signal as applied to the WiFi antenna 440, this is then delayed appropriately by the delay circuit 405, after which the delayed signal is attenuated and phase shifted by the polar modulator 465. This signal is applied to the summation circuit 475 such that it cancels transmitter leakage 490 from the WiFi antenna 440 to the WiMAX antenna 480 which would otherwise be applied to the WiMAX receiver amplifier 460. The appropriate control signals for the polar modulator 465 and delay circuit 405 are applied from the coefficient engine 464 which receives a measure of the WiMAX Rx power from the Rx power detector 463, in dependence upon the status of the coefficient engine 464 as established by the Tx enable signal applied at port 450C.

Optionally the delay provided by the delay circuit 405 is adjustable, selectable, or fixed. Whilst a fixed static delay is certainly practical for some applications wherein cost demands or deployment likelihoods allow, adjustable delay provides cancellation over a broader application and deployment base. The coupler 415 is shown integrated into the WiFi transceiver 430, the delay circuit is shown as a discrete element, and the polar modulator 465 is integrated into the WiMAX transceiver 450. Optionally the coupler/transceiver integration is achieved using semiconductor integrated circuits. Further optionally, the delay circuit 405 is integrated into one or other transceiver. Further optionally all elements of the active cancellation multi-standard device 400 are implemented as a single integrated circuit.

It would be further evident that the approach provides active cancellation even if the WiFi antenna 440 and WiMAX antenna 480 are replaced with a single antenna and a duplexer. Further the polar modulator 465 is controllable by either digital input signals or analog input signals applied to amplitude control port 465A and phase control port 465B.

A first benefit of this active cancellation arrangement is that the WiFi interference is removed at the input block to the WiMAX receiver, reducing its required instantaneous dynamic range. Only signals originating at the co-located WiFi transmitter, being part of the WiFi transceiver 430, are cancelled; sensitivity to other signals is not impaired beyond a small thermal penalty imposed by the summation circuit 475. Beneficially this active cancellation not only addresses leakage from the main lobe of the interferer solving the WiMAX receiver clipping problem, but also the out-of-band leakage is cancelled. Thus adjacent and out-of-band leakage of the WiFi transmitter signal, commonly referred to as spurs and transmitted noise, are at least partially cancelled.

It would be beneficial at this point to address performance limits, as with any physical implementation active cancellation has some performance limits. Thermal noise floor has been mentioned above. The other limits can be understood by realizing that cancellation is essentially a subtraction of two signals to produce an error signal ξ(t) at the input port of the WiMAX receiver amplifier 460, typically a low-noise amplifier (LNA). Considering simplistically that the reference signal is cos(ωt) then ξ(t) can be expressed as:

ξ(t)=cos(ωt)−[a*cos(ω(t−d)+b)] (4)

Where [a*cos(co(t−d)+b)] is the cancellation signal provided through the coupler 415, delay circuit 405 and polar modulator 465 combination. Here ω=2πf, the angular frequency, a is the amplitude scaling of the polar modulator 465, d is a delay error of polar modulator 465, and b is the phase shift of the polar modulator. Ideally a=1 and b=d=0; in order to allow a conventional error expression of the amplitude error, A, to be used;

a=100̂(−A/20) (5)

In this exemplary embodiment, a and b are adjustable by the polar modulator 465. If b is adjusted through 360 degrees with reasonable resolution it is always possible to produce a cancellation null at a frequency ω₀=b/d. The depth of the null is determined by magnitude a, and the “sharpness” of the null is determined by the delay error d. If the delay error is 0 then a and b are adjustable to a pair of values that provides cancellation at all frequencies. The cancellation, Ψ, in dB is then expressed as:

Ψ=10*log(|ξ(t)|̂2) (6)

such that

Ψ=10*log(1+a²−2*a*cos(b−xd)) (7)

where (x=ω−ω₀) is the frequency offset from the null frequency ω₀. Suppose, within the exemplary embodiment of the active cancellation multi-standard device 400 of FIG. 4 that 20 dB of cancellation is specified across the WiFi band. If the null is placed in the center of the band, maximum frequency offset x is (2485−2400)/2=42.5 MHz. With a perfect polar modulator, the resulting delay mismatch is about 350ps. With perfectly matched delays, the resulting polar modulator errors are 0.5 dB and 5 degrees, respectively, for amplitude and phase. These are modest values for monolithically integrated polar modulators compatible with WiMAX integrated circuit technologies.

Within the exemplary embodiment of FIG. 4 the polar modulator 465 positioning the cancellation null at the wanted receiver frequency, as opposed to the transmitter frequency, achieves cancellation of the transmitter leakage 490 from the WiFi antenna 440 to the WiMAX antenna 480. Accordingly the transmitter nulling results in the in-band power at the output of the WiMAX transceiver 450 at port 450A is solely the desired WiMAX carrier 485. As such the coefficient engine 464 seeks to minimize the detected power as measured by the Rx power detector 463, which receives the tapped portion of the band, limited WiMAX carrier provided at the output port 450A.

Whilst the exemplary embodiments presented in FIGS. 4, 8, 9, and 10 are presented and discussed in respect of polar modulators for providing amplitude and phase adjustment of the tapped portion of the WiFi transmitter signal, the requisite amplitude and phase adjustments can also be provided by Cartesian modulation techniques.

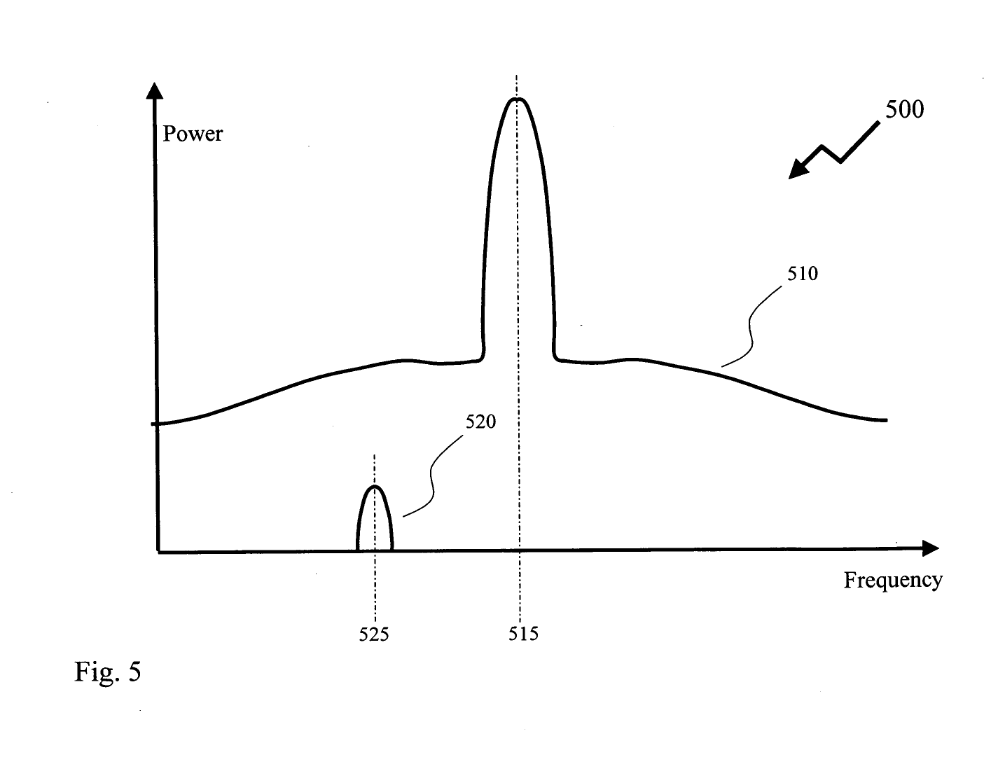

FIG. 5 illustrates an exemplary spectrum 500 of a first transmission signal 510 from a first WiFi system operating within the same frequency band as a receive signal 520 for a WiMAX collocated system. As shown, the first transmission signal 510 is centered at a frequency 515 that is offset from the WiMAX centre frequency 525 of the transmitter providing the receive signal 520 in the collocated WiMAX system.

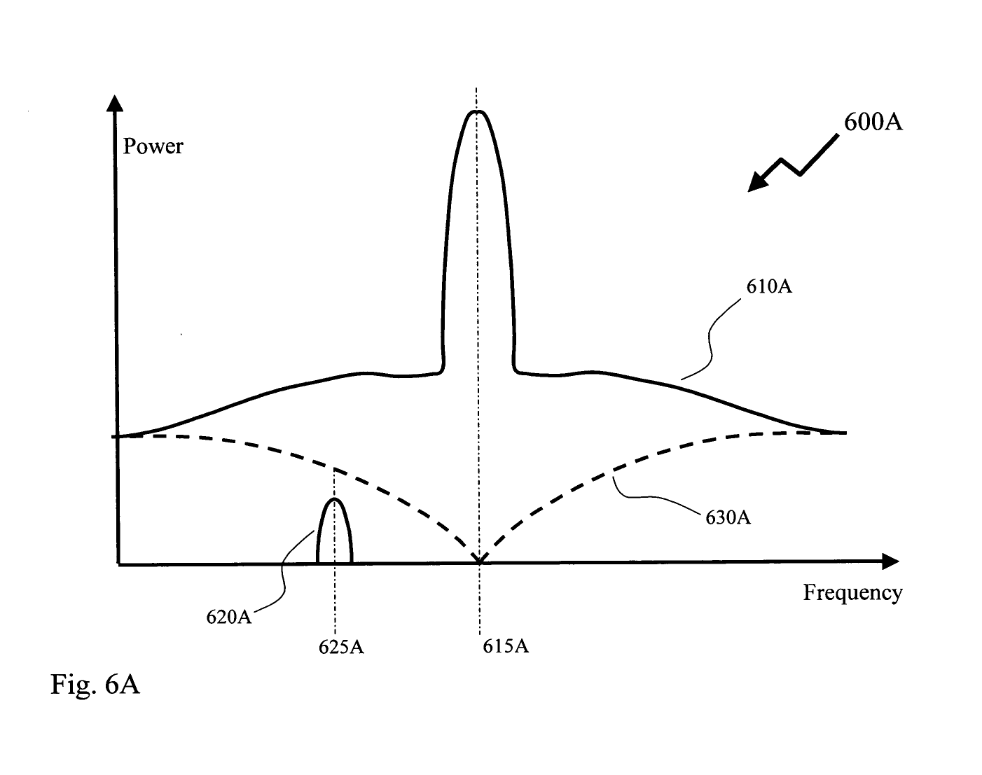

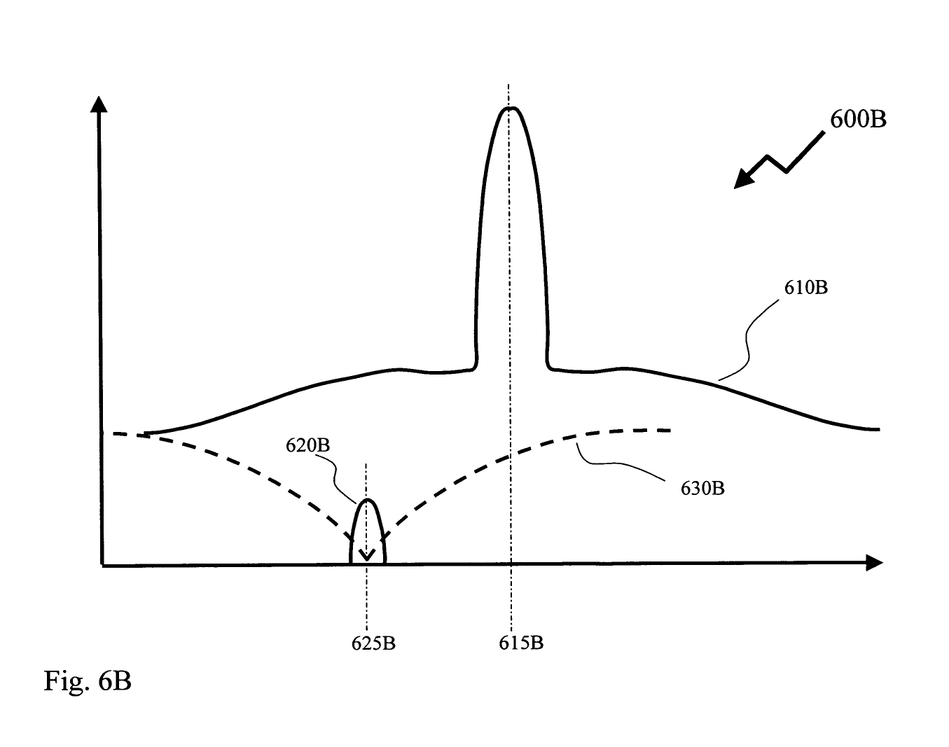

FIG. 6A illustrates a second spectrum 600A of a cancellation signal 630A according to an embodiment such as that outlined in FIG. 4. The exemplary second spectrum 600A comprises a first transmission signal 610A from a first WiFi system operating within the same frequency band as a receive signal 620A for a WiMAX collocated system. As shown, the first transmission signal 610A is centered at a frequency 61 5A that is offset from the WiMAX centre frequency 625A of the transmitter providing the receive signal 620A in the collocated WiMAX system. As shown, the cancellation null of the cancellation signal 630A is centered at the same center frequency 615A as the WiFi system. Thus total interferer signal input power is approximately minimized.

FIG. 6B illustrates an exemplary third spectrum 600B of a cancellation signal 630B according to an embodiment. The exemplary third spectrum 600B comprises a first transmission signal 610B from a first WiFi system operating within the same frequency band as a receive signal 620B for a WiMAX collocated system. As shown, the first transmission signal 610B is centered at a frequency 615B that is offset from the WiMAX centre frequency 625B of the transmitter providing the receive signal 620B in the collocated WiMAX system. As shown, the cancellation null of the cancellation signal 630B is centered at the same center frequency 625B as the WiMAX receiver. Thus receiver sensitivity is approximately maximized.

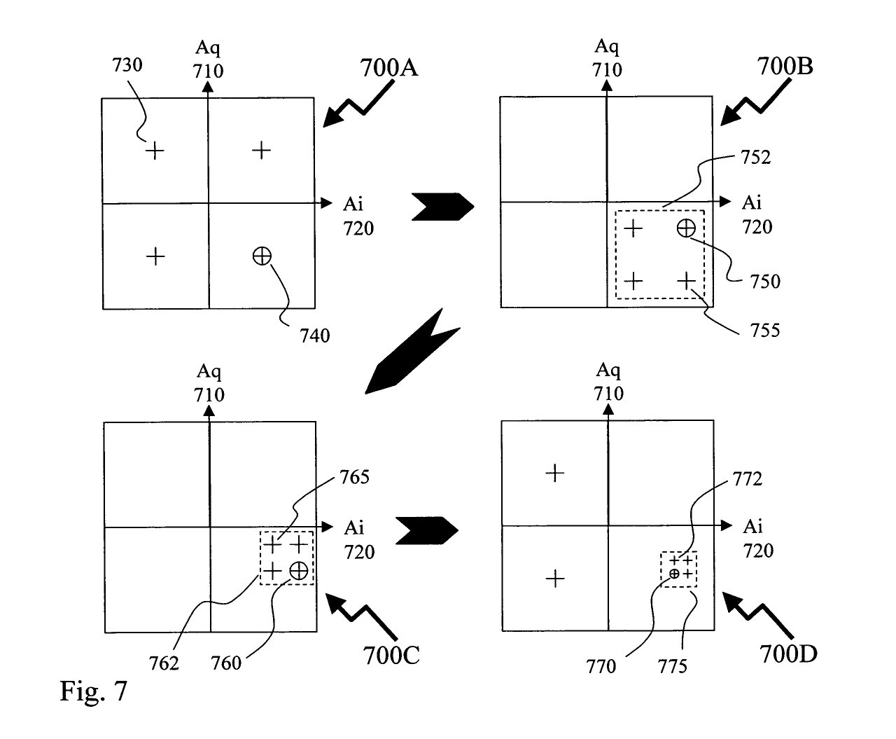

As outlined previously in respect of FIG. 4 establishing the appropriate cancellation signal arises when the polar modulator 465 is provided, by the coefficient engine 464, with the appropriate control signals, the first applied from the amplitude control port 465A and second from the phase control port 465B. FIG. 7 illustrates a two dimensional binary search algorithm for establishing the coefficients to be provided from the coefficient engine 464 to the polar modulator 465.

Shown is a first stage search 700A displayed as a two dimensional surface with abscissa Ai 720 representing the amplitude of the in-phase component of the transmitter signal conversion to form the cancellation signal, and ordinate Aq 710 representing the quadrature component. As shown the coordinate engine 464 initially establishes four initial states 730 for the polar modulator 465. From these the preferred initial state 740 provides the lowest Rx detected power as determined from the signal received at the coordinate engine 464 from the Rx power detector 463. As such the preferred initial state 740 is represented by states wherein Ai=1xxx and Aq=0xxx.

The coordinate engine 464 then moves onto second stage 700B, establishing a restricted search space 752 within a quadrant of the two dimensional coordinate space. The four second stage states 755 are established sequentially from which the coordinate engine 464 selects a second preferred state 750 represented by Ai=11xx; Aq=01xx.

Now the coordinate engine 464 then moves onto third stage 700C, establishing a restricted search space 762. Now four third stage states 765 are established sequentially from which the coordinate engine 464 selects a second preferred state 760 represented by Ai=111x; Aq=010x. Finally, in this exemplary embodiment the coordinate engine performs a fourth stage 700D of coordinate refinement. In the further restricted final search space 775 the coordinate engine 464 again establishes four final states 772 and selects the final preferred state 770 representing coordinates Ai =1110 and Aq=0100.

Subsequently, the coordinate engine 464 performs state searches around the currently selected state 770 to identify whether a new state now represents an improved cancellation of the transmitter signal. It will be appreciated that the coordinate engine 464 can have the search process gated with the Tx Enable signal, which is applied at port 450C of the exemplary embodiment described in respect of FIG. 4. As such the coordinate engine 464 only performs a state search when the transmitter is active, namely when Tx Enable=“HIGH”.

For the time that the transmitter is inactive. Tx Enable=“LOW”, the coordinate engine 464 within this embodiment maintains the polar modulator 465 with the last selected states and suspends subsequent searches as now there is no superimposed transmitter crosstalk to null. It would be understood that other options exist during the period of time Tx Enable=“LOW”. Such options include, but are not limited to, optionally placing the polar modulator 465 into a predetermined dormant state such that the nulling applied from the polar modulator 465 is now at a frequency outside the frequency range of interest for the receiver, or turning the polar modulator 465 off to minimize power consumption and reduce noise applied to the receiver from this part of the circuit.

It will be further evident to one skilled in the art that the search algorithm employed in establishing the polar modulator 465 control signals from the coordinate engine 464 can employ a variety of algorithms, without departing from the scope of the invention.

Further, whilst WiFi transceivers, such as WiFi transceiver 130 of FIG. 1, according to IEEE 802.11b/g, have essentially been commoditized in the past few years, the interference problem with WiMAX transceivers, such as WiMAX transceiver 150, is mutual. Although front-end filters are typically used for the WiFi receiver, the WiMAX out-of-band leakage remains unfilterable and can present a problem. Consider, an example wherein the WiMAX transceiver, such as WiMAX transceiver 150, has an output power of +24 dBm, out-of-band leakage is at −35 dBc and antenna isolation is 20 dB. In this scenario the WiFi transceiver receives WiMAX leakage at −31 dBm. As such, it is evident that active cancellation is applicable to each transceiver within a multi-standard device.

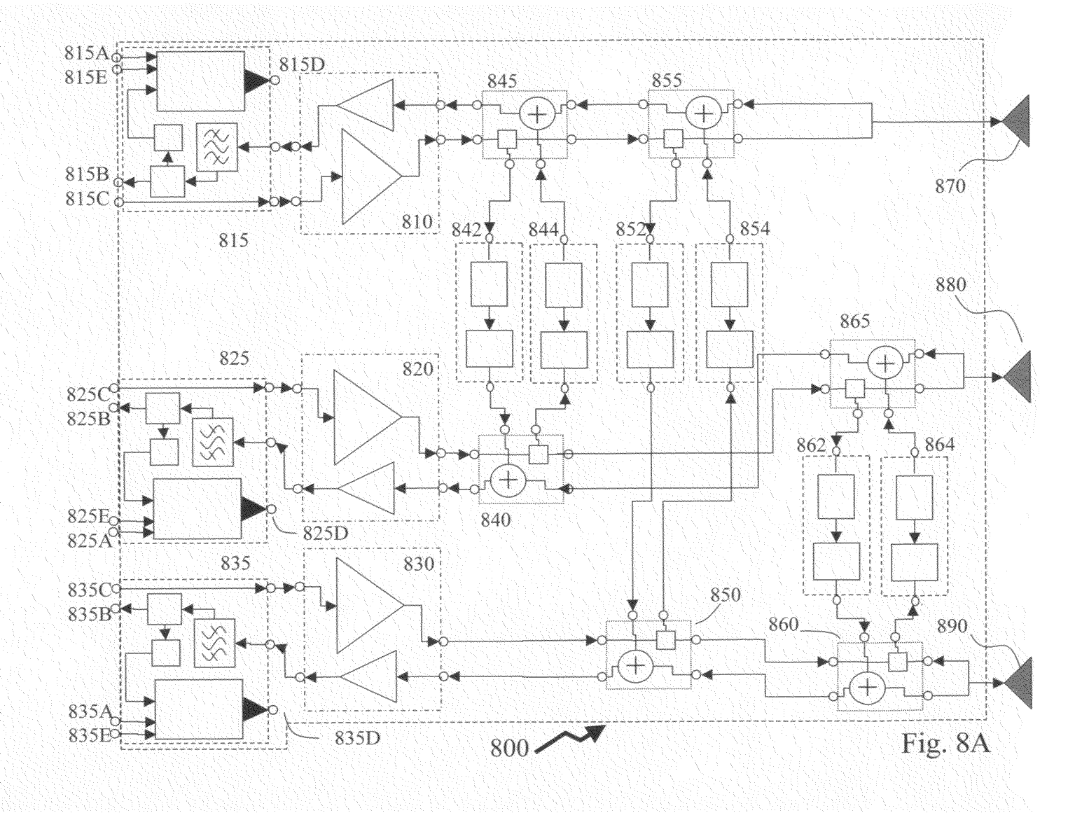

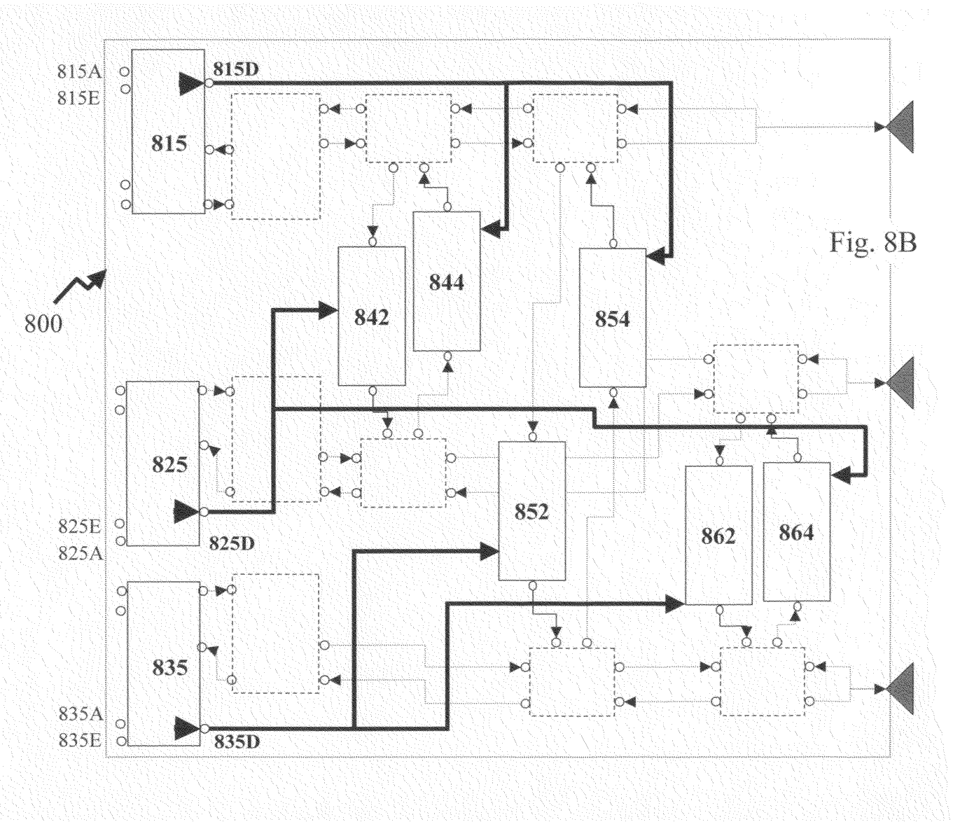

Such an exemplary second embodiment of the invention is shown in FIG. 8A for a multi-standard 2.5 GHz wireless device 800. As shown the multi-standard 2.5 GHz wireless device 800 comprises an IEEE 802.11g transceiver amplifier block 810, an IEEE 802.16e transceiver amplifier block 820 and a Bluetooth™ transceiver amplifier block 830. Electrically coupled to the IEEE 802.11g transceiver amplifier block 810 is a first coupler and summation circuit 845, a second coupler and summation circuit 855 and first antenna 870. Similarly, electrically coupled to the IEEE 802.16e transceiver amplifier block 820 are a third coupler and summation circuit 840, a fourth coupler and summation circuit 865 and second antenna 880. Finally, electrically coupled to the Bluetooth™ transceiver amplifier block 830 is a fifth coupler and summation circuit 850, a sixth coupler and summation circuit 860 and third antenna 890.

The first coupler and summation circuit 845 and third coupler and summation circuit 840 are electrically coupled via a first delay and polar modulation circuit 842 and second delay and polar modulation circuit 844. In operation, the first delay and polar modulation circuit 842 receive a sampled portion of the transmitted signal from the IEEE 802.11g transceiver amplifier block 810 via the first coupler and summation circuit 845, and provide this to the third coupler and summation circuit 840 to provide appropriate cancellation to the IEEE 802.16e transceiver amplifier block 820. Likewise, the second delay and polar modulation circuit 844 receive a sampled portion of the transmitted signal from the IEEE 802.16e transceiver amplifier block 820 via the third coupler and summation circuit 840, and provide this to the first coupler and summation circuit 845 to provide cancellation to the IEEE 802.11g transceiver amplifier block 810.

The second coupler and summation circuit 855 and fifth coupler and summation circuit 850 are electrically coupled via a third delay and polar modulation circuit 852 and fourth delay and polar modulation circuit 854. In operation, the third delay and polar modulation circuit 852 receives a sampled portion of the transmitted signal from the IEEE 802.11g transceiver amplifier block 810 via the third coupler and summation circuit 855, and provides this to the fifth coupler and summation circuit 850 to provide cancellation to the Bluetooth™ transceiver amplifier block 830. Likewise, the fourth delay and polar modulation circuit 854 receives a sampled portion of the transmitted signal from the Bluetooth™ transceiver amplifier block 830 via the fifth coupler and summation circuit 850, and provides this to the second coupler and summation circuit 855 to provide cancellation to the IEEE 802.11g transceiver amplifier block 810.

The fourth coupler and summation circuit 865 and sixth coupler and summation circuit 860 are electrically coupled via a fifth delay and polar modulation circuit 862 and sixth delay and polar modulation circuit 864. In operation, the fifth delay and polar modulation circuit 862 receives a sampled portion of the transmitted signal from the IEEE 802.16e transceiver amplifier block 820 via the fourth coupler and summation circuit 865, and provides this to the sixth coupler and summation circuit 860 to provide cancellation to the Bluetooth™ transceiver amplifier block 830. Likewise, the sixth delay and polar modulation circuit 864 receives a sampled portion of the transmitted signal from the Bluetooth™ transceiver amplifier block 830 via the sixth coupler and summation circuit 860, and provides this to the fourth coupler and summation circuit 865 to provide cancellation to the IEEE 802.16e transceiver amplifier block 820.

Electrically coupled to the other end of the IEEE 802.11g transceiver amplifier block 810 is the first detector and coordinate generator 815. Whilst not explicitly identified for clarity, the first detector and coordinate generator 815 contains a passband limiting filter, equivalent to band limiting filter 461, power tap coupler, equivalent to Rx tap coupler 462, power detector, equivalent to Rx power detector 463, which provide a passband limited power measurement of the received signal within the IEEE 802.11g receive channel. This measurement being provided to a coordinate controller, equivalent to the coordinate engine 464, to generate the appropriate control signals to null the transmitter crosstalk from both the IEEE 802.16e transceiver and Bluetooth™ transceiver. As such the output from the first detector and coordinate generator 815 is an array of control signals at port 815D. These control signals electrically connected to the second delay and polar modulation circuit 844, which processes the transmitter signal from the IEEE 802.16e transceiver, and the fourth delay and polar modulation circuit 854, which processes the transmitter signal from the Bluetooth™ transceiver. These electrical interconnections not shown for clarity in FIG. 8A but are presented subsequently in respect of FIG. 8B. The first detector and coordinate generator 815 provides an IEEE 802.11g receive port 815B at which the passband filtered and crosstalk nulled IEEE 802.11g signal is provided to the subsequent additional circuit elements of the IEEE 802.11g transceiver, an IEEE 802.11g transmit port 815C which receives the IEEE 802.11g signal for transmission from the preceding additional circuit elements of the IEEE 802.11g transceiver. Further the first detector and coordinate generator 815 has an IEEE 802.16e transmit enable control port 815A, which receives the IEEE 802.16e transmit enable signal from the IEEE 802.16e transceiver, and a Bluetooth™ transmit enable port 815E, which receives the Bluetooth™ transmit enable signal from the Bluetooth™ transceiver.

Similarly, electrically coupled to the other end of the IEEE 802.16e transceiver amplifier block 820 is the second detector and coordinate generator 825. The output from this second detector and coordinate generator 825 is an array of control signals at port 825D. These control signals electrically connected to the first delay and polar modulation circuit 842, which processes the transmitter signal from the IEEE 802.11g transceiver, and the sixth delay and polar modulation circuit 864, which processes the transmitter signal from the Bluetooth™ transceiver. These electrical interconnections not shown for clarity in FIG. 8A but are presented subsequently in respect of FIG. 8B. The second detector and coordinate generator 825 provides an IEEE 802.16e receive port 825B at which the passband filtered and crosstalk nulled IEEE 802.16e signal is provided to the subsequent additional circuit elements of the IEEE 802.16e transceiver, an IEEE 802.16e transmit port 825C which receives the IEEE 802.16e signal for transmission from the preceding additional circuit elements of the IEEE 802.16e transceiver. Further the second detector and coordinate generator 825 has an IEEE 802.11g transmit enable control port 825A, which receives the IEEE 802.11g transmit enable signal from the IEEE 802.11g transceiver, and a Bluetooth™ transmit enable port 825E, which receives the Bluetooth™ transmit enable signal from the Bluetooth™ transceiver.

Electrically coupled to the other end of the Bluetooth™ transceiver amplifier block 810 to the fifth coupler and summation circuit 850 is the third detector and coordinate generator 835. The output from the first detector and coordinate generator 815 is an array of control signals at port 835D. These control signals electrically connected to the third delay and polar modulation circuit 844, which processes the transmitter signal from the IEEE 802.11g transceiver, and the fifth delay and polar modulation circuit 862, which processes the transmitter signal from the IEEE 802.16e transceiver. These electrical interconnections not shown for clarity in FIG. 8A but are presented subsequently in respect of FIG. 8B. The third detector and coordinate generator provides an Bluetooth™ receive port 835B at which the passband filtered and crosstalk nulled Bluetooth™ signal is provided to the subsequent additional circuit elements of the Bluetooth™ transceiver, an Bluetooth™ transmit port 835C which receives the Bluetooth™ signal for transmission from the preceding additional circuit elements of the Bluetooth™ transceiver. Further the third detector and coordinate generator 835 has an IEEE 802.16e transmit enable control port 835A, which receives the IEEE 802.16e transmit enable signal from the IEEE 802.16e transceiver, and an IEEE 802.11g transmit enable port 815E, which receives the IEEE 802.11g transmit enable signal from the IEEE 802.11g transceiver.

Alternatively the transceivers are solely discrete transmitters or discrete receivers, or multiple transceivers of a first standard are co-located or closely associated with a transceiver of a second standard. As is evident many alternative configurations of transmitters, receivers, transceivers, antenna, multiple standards etc are possible. It is further evident that the multiple standards are any of a number of particular combinations of wireless standards, including but not limited to GSM/GPRS at 850 MHz, 900 MHz, 1800 MHz, and 1900 MHz, IEEE 802.11 systems of any variant for WiFi, IEEE 802.16 systems of any variant for WiMAX, IEEE 802.15 systems of variants for ZigBee, wireless USB, Bluetooth™, DECT, Wireless Distribution System, and DSRC.

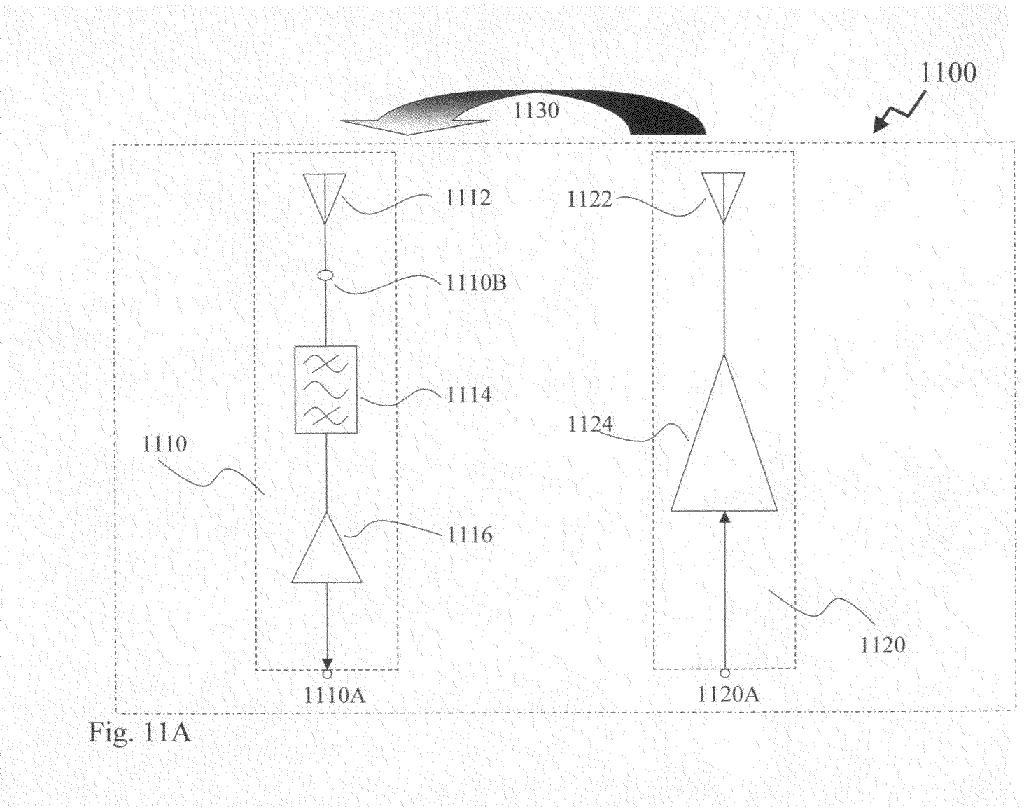

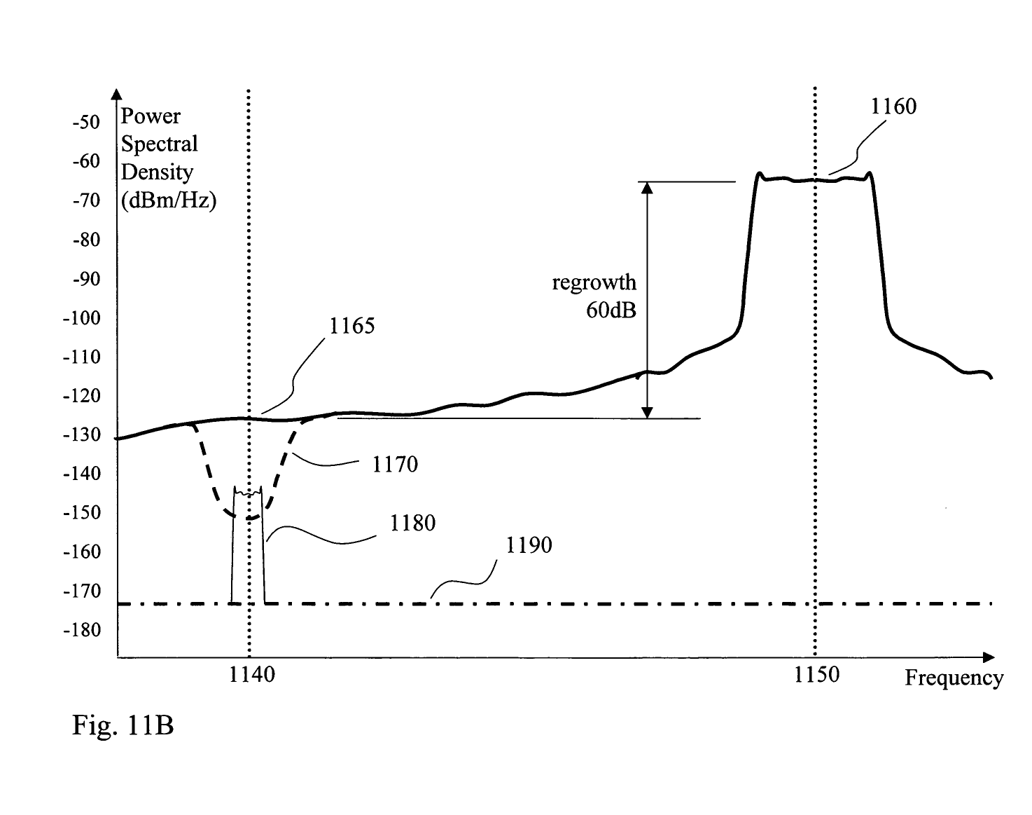

Also the wireless systems being cancelled or enhanced by the adoption of active cancellation is optionally other non-wireless communications systems such as microwave ovens—emitting typically at 2450 MHz, RFID tags, global positioning systems (GPS and Galileo), and global navigation satellite systems (GNSS). Though it seems that the lowest frequency band for WiMAX according to IEEE 802.16e of 2300-2600 MHz is quite far from the GNSS bands of 1575±2 MHz (GPS) and 1575±4 MHz (Galileo) the GNSS signals are extremely low power, in fact the signals are typically within the noise and GNSS receivers rely on correlation gain to extract the signal from the noise. As a result a further 25 dB of attenuation in the splatter from active cancellation is beneficial in minimizing the time needed to acquire the low level GNSS signal with correlation gain against the backdrop of noise. Such an exemplary embodiment will be described subsequently in respect of FIG. 11.

As outlined previously, each of the detector and coordinate generators 815, 825, and 835 is electrically coupled to the appropriate delay and polar modulation circuits, which are interconnected to transceivers providing transmitters generating crosstalk signals. These interconnections are shown in FIG. 8B, with the remaining elements of multi-standard 2.5 GHz wireless device 800 shown simply as functional blocks. As such the first detector and coordinate generator 815 is electrically connected from the control signal port 815D to the second delay and polar modulation circuit 844 and fourth delay and polar modulation circuit 854. According to the previous exemplary embodiment of coordinate generation the second delay and polar modulation circuit 844 is controlled in accordance with the IEEE 802.16e transmit enable signal provided at the IEEE 802.16e transmit enable control port 815A, and the fourth delay and polar modulation circuit 854 is controlled in accordance with the Bluetooth™ transmit enable signal provided at the Bluetooth™ transmit enable control port 815E.

The second detector and coordinate generator 825 is electrically connected from its control signal port 825D to the first delay and polar modulation circuit 842 and sixth delay and polar modulation circuit 864. The first delay and polar modulation circuit 842 is controlled in accordance with the IEEE 802.11g transmit enable signal provided at the IEEE 802.11g transmit enable control port 825A, and the sixth delay and polar modulation circuit 864 is controlled in accordance with the Bluetooth™ transmit enable signal provided at the Bluetooth™ transmit enable control port 825E.

Finally, the third detector and coordinate generator 835 is electrically connected from its control signal port 835D to the third delay and polar modulation circuit 852 and fifth delay and polar modulation circuit 862. The third delay and polar modulation circuit 852 is controlled in accordance with the IEEE 802.11g transmit enable signal provided at the IEEE 802.11g transmit enable control port 835A, and the fifth delay and polar modulation circuit 862 is controlled in accordance with the IEEE 802.16e transmit enable signal provided at the IEEE 802.16e transmit enable control port 835E.

In operation, continuing the exemplary Ai and Aq coordinates presented previously in respect of FIG. 7, as the leakage from each transmitter to a receiver is independent then each coordinate controller within the detector and coordinate generators 815, 825 and 835 can independently adjust the Ai, Aq coordinates for each interfering transmitter. As such within the exemplary embodiment of FIGS. 8A and 8B each coordinate controller being able to independently adjust the four coordinates. Additional transmitters can be accommodated in a similar manner.

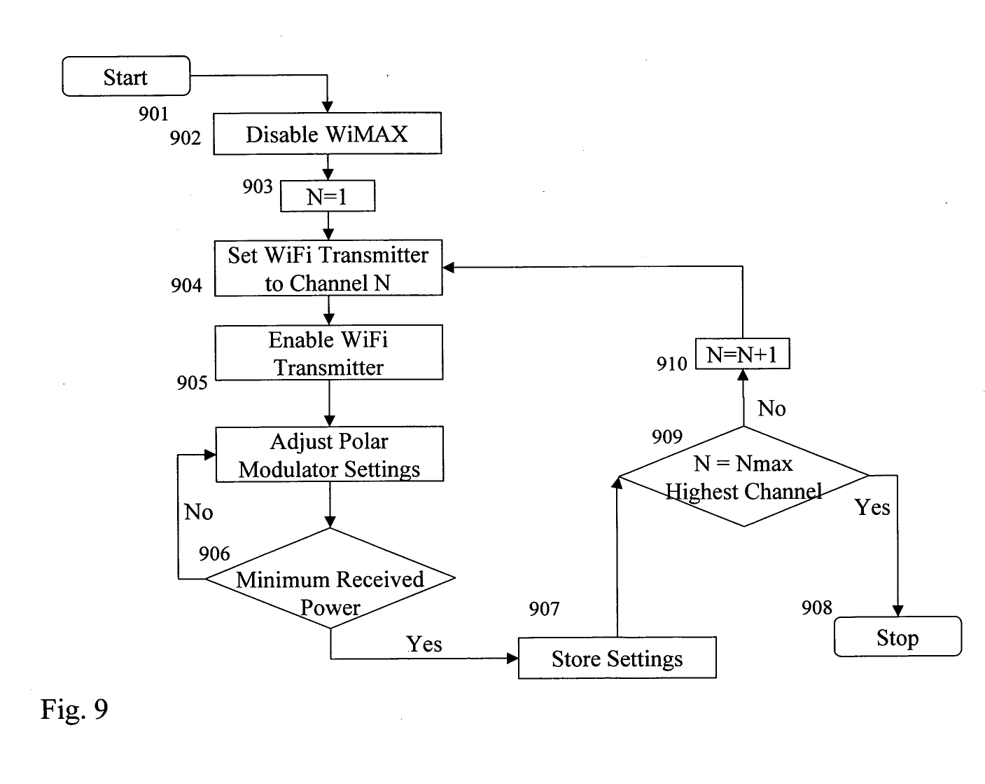

The physical delay and delay mismatch are typically very short in a laptop or similar environments. The antenna-to-antenna transfer function is likely to be dominated by near-field coupling and typically is largely immune to objects nearby. In such scenarios a static delay is optionally provided rather than an adjustable delay, and a calibration process obtains the polar modulator settings, for example. Such a calibration process is shown in FIG. 9.

As shown, upon starting the calibration process at step 901 the WiFi transceiver is enabled and the WiMAX transmitter disabled. At step 902 a counter value N is set to 1, and the WiFi transmitter is set to the first channel (N=1) at step 903. With the WiMAX transmitter disabled establishing a near optimum polar modulator setting is achieved by determining when minimum RF power is received and detected, through steps 905 and 906, at which point the polar modulator settings are stored in step 907. If the counter N is equal to the highest channel number, step 909, then the calibration is stopped at step 908. If not, the counter N is incremented at step 910, and the calibration cycle repeated for the next channel N+1. In this manner the settings can be stored for each of the WiFi transmitter channels allowing the null to be placed on either the sole channel present, or the most significant WiFi transmitter channel being used, thereby supporting higher values of cancellation. Such an approach optionally including a WiFi channel determination circuit within the transceiver, after the WiFi filter such as first filter 320 of FIG. 3. Optionally, the calibration is updated for a channel, or established initially using a “trickle” calibration. Such a “trickle” calibration is optionally performed during idle times, when the WiMAX transmitter is not actively transmitting signal data for example. Such a “trickle” calibration allows the polar modulator settings to mitigate effects of physical changes in the nearby environment.

Alternatively, the settings when stored for each of the WiFi channels allow the null to be placed on the actual channel being used, supporting higher values of cancellation. Alternatively, the null is placed on the WiMAX receiver frequency to approximately maximize sensitivity. Optionally, the calibration is updated for a channel, or established initially using a “trickle” calibration. Such a “trickle” calibration is optionally performed during idle times, when the WiMAX transmitter is not actively transmitting signal data for example. Such a “trickle” calibration allows the polar modulator settings to mitigate effects of physical changes in the nearby environment.

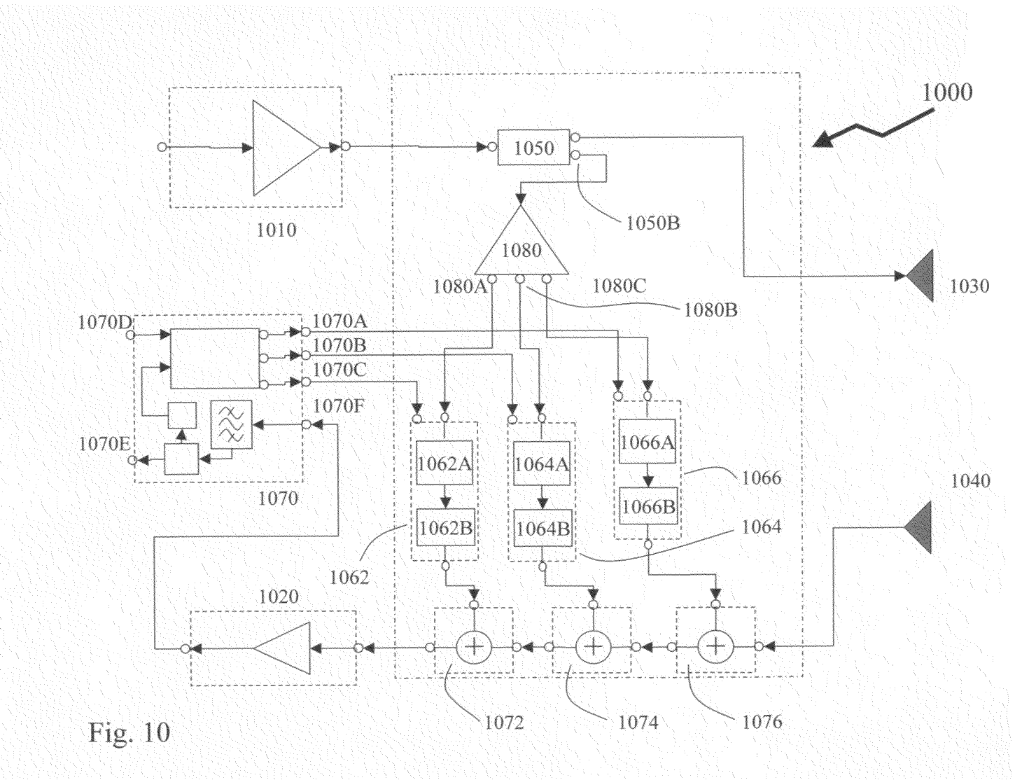

Now referring to FIG. 10 shown is a multiple cancellation circuit 1000 wherein multiple cancellation elements are provided for actively cancelling transmitter leakage. A transmitter 1010 operating according to a first standard, such as IEEE 802.11g, is electrically coupled to a transmission antenna 1030 via a coupler 1050. As with the previous couplers, such as 415 of FIG. 4, the coupler 1050 provides a second output signal at tap port 1050B, which is a portion of the signal, applied to it. Typically such coupler 1050 portions are 1%, 2%, 5% or 10% although many fixed values of the portion are possible. Alternatively, coupler 1050 is a dynamically adjustable coupler.

The portion of the transmit signal from the transmitter 1010 is then electrically coupled to splitter 1080 which provides three splitter output signals 1080A, 1080B, and 1080C each having a power approximately equal to one third of the signal at tap port 1050B. The first splitter output signal 1080A is coupled to the first cancellation circuit 1062 which comprises a first time delay 1062A and first polar modulator 1062B. The first time delay 1062A provides a time delay similar to time delay 405 of FIG. 4, and the first polar modulator 1062B provides amplitude and phase adjustments similar to the polar modulator 465 of FIG. 4. The output port of the first cancellation circuit 1062 is coupled to first summing circuit 1072.

The second splitter output signal 1080B is coupled to second cancellation circuit 1064 which comprises a second time delay 1064A and second polar modulator 1064B. The output port of the second cancellation circuit 1064 is coupled to the second summing circuit 1074. The third splitter output signal 1080C is coupled to third cancellation circuit 1066 which comprises a second time delay 1066A and third polar modulator 1066B. Similarly, the output port of the third cancellation circuit 1066 is coupled to the third summing circuit 1076. The third summing circuit 1076 receives a detected signal from receive antenna 1040, and the first summing circuit 1072 provides an actively cancelled receive signal to receiver 1020.

The receiver 1020 is then electrically coupled to the generator 1070 at its microwave receipt port 1070F. Internally the generator 1070 being functionally similar to the detector and coordinate generators discussed previously in respect of FIG. 8A such as the first detector and coordinate generator 815. As such the generator 1070 provides a passband limiting filtered version of the signal received from the receiver 1020 at it's microwave output port 1070E, and receives a transmitter enabled control signal at it's transmitter control port 1070D. Within this embodiment the transmitter enabled control signal being in respect of the transmitter 1010. The generator 1070 is electrically connected from it's third coordinate port set 1070C to the first cancellation circuit 1062, thereby providing appropriate control signals to the first cancellation circuit 1062. Similarly, the generator is connected to the second cancellation circuit 1064 from its second coordinate port set 1070B, and to the third cancellation circuit 1066 from its third coordinate port set 1070A.

In this embodiment, each of the cancellation circuits 1062, 1064 and 1066 are set to slightly different settings allowing nulling of the transmit signal contained within the detected signal with both wider and deeper nulls in the effective filter profile of the cancellation circuit. Alternatively where multiple transmit signals were generated by the transmitter 1010 simultaneously, the multiple cancellation circuits 1062 through 1066 are optionally individually tuned for each of the multiple transmit signals and the passive splitter 1080 is replaced by either fixed or tunable filtering elements. In this manner not only are multiple transmit central frequencies actively cancelled by a frequency hopping transmitter, but also may are optionally actively cancelled absent rapid switching of the time delay element, such as first time delay 1062A, and adjustment of amplitude and phase, such as by the first polar modulator 1062B. Optionally, the multiple summing circuits 1072 through 1076 are replaced with a single combiner or summing circuit.

As discussed supra in respect of FIG. 8A active cancellation of transmitter leakage into a GPS receiver, or GNSS receiver, collocated or in close proximity provides potential benefit in minimizing the time needed to acquire the low level navigation signal using correlation gain against the backdrop of thermal noise and splatter from the transmitter. Such an exemplary embodiment is discussed below in respect of the transceivers illustrated in FIG. 11A and the exemplary spectrum of FIG. 11B.

Shown in FIG. 11A is a WiMAX transmitter 1120 and a co-located GPS receiver 1110 within a device 1100. As shown the WiMAX transmitter comprises an RF input port 1120A for receiving a WiMAX transmit signal according to IEEE 802.16e having a centre frequency at the 2400 MHz. The RF input port 1120A is electrically coupled to the power amplifier 1124 which amplifies the WiMAX transmit signal ready for broadcasting from the antenna 1122, in this exemplary embodiment with a transmit power of +24 dBm.

The GPS receiver 1110 comprises a receiving antenna 1112, which being a broadband antenna receives the intended GPS signal and leakage from the WiMAX transmitter 1120 as represented by the crosstalk path 1130. The electrical signal from the GPS receiver 1112 is coupled to a narrow passband filter 1114, which for the GPS standard would have a passband from 1574-1576 MHz. The filtered signal from the narrow passband filter 1114 is then coupled to the GPS low noise amplifier 1116 and provided to the RF output port 1110A of the GPS receiver.

FIG. 11B illustrates an exemplary power spectrum seen at measurement node 1110B of the GPS receiver 1110 for the embodiment of actively cancelling the leakage between the WiMAX transmitter 1120 and GPS receiver 1110 wherein the crosstalk path 1130 attenuates the transmitted signal by 20 dB. The figure plots power spectral density (PSD) as a function of frequency, wherein power spectral density is defined as in equation 8 below.

Power Spectral Density=Power in dBm−10*log (Bandwidth) (8)

Shown within FIG. 11B is first marker 1140 representing the centre frequency 1575 MHz of the GPS receiver 1110 and second marker 1150 representing the centre frequency 2400 MHz of the WiMAX transmitter 1120. Also shown is the GPS received power spectral density (PSD) curve 1180 representing the GPS received signal, and the WiMAX crosstalk PSD curve comprising the WiMAX PSD 1160 and regrowth PSD 1165. Also shown is the cancelled PSD 1170 provided by an active cancellation according to an exemplary embodiment of the invention such as FIG. 8A.

Consider, as an example, that the WiMAX transmitter 1120 radiates a transmitted power of +24 dBm within a 10 MHz bandwidth resulting in the WiMAX PSD 1160, using Eq. 8 below of −46 dBm/Hz {−46=+24−10log(10e6)}. The 20 dB attenuation of the transmitted signal by way of the crosstalk path 1130 results in the GPS receiver sees a WiMAX PSD 1160 at measurement node 1110B of −66 dBm/Hz at the second marker 1150. The narrow passband filter 1114 will filter this signal out, but the WiMAX transmitter regrowth 1165 as shown is only 60 dB down from the WiMAX transmit level. As such the regrowth PSD 1165 is −126 dBm/Hz, and since it is in-band with the desired GPS signal, represented by GPS receive PSD 1180, the narrow passband filter 1114 cannot filter it out.

If we consider that the upper in-band signal level for the GPS receiver 1110 might be in the range of −80 dBm (corresponding to a GPS receive PSD 1180 of −143 dBm/Hz ), then the WiMAX regrowth PSD 1165 will clearly wipe-out the GPS receiver at it's upper limit!

Now consider that active cancellation is applied between the WiMAX transmitter 1120 and GPS receiver 1110, and that the cancellation null is placed at the first marker 1140 of 1575 MHz with a cancellation depth of 25 dB. Now the cancellation null with transmitter regrowth provides the cancelled PSD 1170 of −151 dB/Hz, being −126 dBm/-25 dB, such that the cancelled PSD 1170 is now 8 dB below the GPS receive PSD 1180 allowing recovery of the GPS signal. Further, as the physical thermal noise floor 1190 is −174 dBm/Hz such a system does not place significant restrictions on the noise figure of the GPS low noise amplifier 1116, and provides room for improvements in the cancellation null to still manifest themselves within the cancelled PSD 1170 and increase operating margin for the GPS receiver 1110.

Numerous other embodiments may be envisaged without departing from the spirit or scope of the invention.

What is claimed is:

1. A method comprising;
providing at least a receiver for receiving signals according to a first wireless standard, the receiver comprising at least one band-limiting filter of a plurality of band-limiting filters;
providing at least a transmitter for transmitting a transmit signal according to a second other wireless standard;
providing a first signal for transmission from the transmitter;
generating a first cancellation signal, the first cancellation signal being at least a portion of the transmit signal and having at least one of a predetermined time delay, predetermined amplitude relationship, and predetermined phase relationship with respect to the transmit signal;
providing the first cancellation signal by other than the transmitter, the first cancellation signal for combining with a received signal received at the receiver; and
generating a control signal, the control signal for controlling an aspect of the generation of the first cancellation signal and being generated in dependence upon a measure of the received signal power after filtering thereof by the band-limiting filters.

2. A method according to claim 1 wherein,
providing the first cancellation signal comprises generating a down-converted signal generated at least in dependence upon the portion of the transmit signal.

3. A method according to claim 2 wherein,
providing the down-converted signal comprises providing the down-converted signal at least one of prior to and after providing at least one of the predetermined time delay, predetermined amplitude relationship, and predetermined phase relationship with respect to the transmit signal.

4. A method according to claim 1 wherein,
providing the first cancellation signal comprises generating at least one of an in-phase baseband signal and quadrature baseband signal generated at least in dependence upon the portion of the transmit signal.

5. A method according to claim 4 wherein,
providing the at least one of an in-phase and quadrature baseband signal comprises providing the at least one of an in-phase baseband signal and quadrature baseband signal at least one of prior to and after providing at least one of the predetermined time delay, predetermined amplitude relationship, and predetermined phase relationship with respect to the transmit signal.

6. A method according to claim 1 wherein,
generating a control signal comprises generating the control signal without dependence upon baseband signals.

7. A method according to claim 1 comprising;
determining a state of the transmitter;
generating the first cancellation signal according to a first state of the transmitter; and,
generating other than the first cancellation signal in a second state of the transmitter.

8. A method according to claim 7 wherein,
determining a state of the transmitter comprises receiving a transmitter enable signal.

9. A method according to claim 7 wherein,
generating other than the first cancellation signal comprises turning off the cancellation circuit.

10. A method according to claim 7 wherein,
generating other than the first cancellation signal comprises generating a second cancellation signal.

11. A method according to claim 10 wherein,
generating the second cancellation signal comprises generating the second cancellation signal according to an aspect of at least one of the first wireless standard and second wireless standard.

12. A method according to claim 7 wherein,
generating other than the first cancellation signal comprises providing a nulling signal, the nulling signal having at least one of a predetermined time delay, predetermined amplitude relationship, and predetermined phase relationship with respect to the transmit signal.

13. A method according to claim 1 wherein,
generating a control signal in dependence upon a measure of the received signal power comprises at least one of measuring the power of the received signal directly and measuring the power of a baseband signal generated from a down-conversion of the received signal.

14. A method according to claim 1 wherein,
providing a transmitter according to the second wireless standard comprises providing a transmitter according to at least one of IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, and IMT-2000.

15. A method according to claim 1 wherein,
providing a receiver according to the first wireless standard comprises providing a receiver according to at least one of IEEE 802.11, IEEE 802.15, IEEE 802.16, IEEE 802.20, UMTS, GSM 850, GSM 900, GSM 1800, GSM 1900, GPRS, Global Navigation Satellite Systems, Global Positioning Systems, Galileo Positioning System, ITU-R 5.138, ITU-R 5.150, and IMT-2000.

16. A method according to claim 1 wherein,
providing the signal to be transmitted comprises providing a signal to be transmitted having a center frequency within a predetermined frequency range of the first wireless standard.

17. A method according to claim 1 wherein,
providing a signal to be transmitted comprises providing a signal to be transmitted having a central frequency outside a predetermined frequency range of the first wireless standard.

18. A method according to claim 17 further comprising,
providing spectral components of the signal to be transmitted within the predetermined frequency range of the first wireless standard.

19. A method according to claim 1 wherein,
generating the first cancellation signal comprises providing a cancellation circuit.

20. A method according to claim 1 wherein,
combining the first cancellation signal with the received signal comprises providing at least the first cancellation signal and received signal to a low noise amplifier summing circuit forming a portion of a receiver circuit operating according to the first wireless standard.

21. A method according to claim 1 wherein,
providing the first cancellation signal comprises providing the first cancellation signal at least in dependence upon at least an operating characteristic of at least one of the first wireless standard, the second wireless standard, the signal to be transmitted, and the received signal.

22. A method according to claim 21 wherein,
an operating characteristic is at least one of a power, a central frequency, a channel number, dynamic range, sensitivity, and bit error rate.

23. A method according to claim 1 wherein,
providing the first cancellation signal comprises providing the first cancellation signal to at least one of reduce the total interfering power from the transmitter within a frequency band according to the first wireless standard and increasing at least one of sensitivity and dynamic range of the receiver.

24. A method according to claim 1 wherein,
providing a first cancellation signal by other than the transmitter comprises providing the first cancellation signal by at least one of an electrical signal, an optical signal, and a wireless signal.

25. A circuit comprising;
at least a receiver for receiving signals according to a first wireless standard, the receiver comprising at least one band-limiting filter of a plurality of band-limiting filters;
at least a transmitter for transmitting a transmit signal according to a second other wireless standard;
a first cancellation signal generating circuit for generating a first cancellation signal in response to a control signal, the first cancellation signal being at least a portion of the transmit signal and having at least one of a predetermined time delay, predetermined amplitude relationship, and predetermined phase relationship with respect to the transmit signal;
a transmission path for providing the first cancellation signal by other than the transmitter, the first cancellation signal for combining with a received signal received at the receiver; and
a control signal output port for providing the control signal for controlling an aspect of the generation of the first cancellation signal and being generated in dependence upon a measure of the received signal power after filtering thereof by the band-limiting filters.

26. A circuit according to claim 25 wherein,
the first cancellation signal generating circuit in generating the first cancellation signal provides a down-converted signal generated at least in dependence upon the portion of the transmit signal.

27. A circuit according to claim 26 wherein,
the first cancellation signal generating circuit generates the down-converted signal at least one of prior to and after providing at least one of the predetermined time delay, predetermined amplitude relationship, and predetermined phase relationship with respect to the transmit signal.

28. A circuit according to claim 25 wherein,
the first cancellation signal generating circuit in generating the first cancellation signal provides at least one of an in-phase baseband signal and quadrature baseband signal generated at least in dependence upon the portion of the transmit signal.

29. A circuit according to claim 27 wherein,
the first cancellation signal generating circuit generates the at least one of an in-phase baseband signal and quadrature baseband signal at least one of prior to and after providing at least one of the predetermined time delay, predetermined amplitude relationship, and predetermined phase relationship with respect to the transmit signal.

30. A method according to claim 1 wherein,
generating a control signal comprises generating the control signal without dependence upon baseband signals.

31. A circuit according to claim 25 wherein,
the first cancellation signal generating circuit comprises a transmitter enable port for receiving a transmitter enable signal from the transmitter, the transmitter enable signal determining a state of the transmitter.

32. A circuit according to claim 31 wherein,
the first cancellation signal generating circuit generates the first cancellation signal according to a first state of the transmitter and generates other than the first cancellation signal in a second state of the transmitter.

33. A circuit according to claim 32 wherein,
the first cancellation signal generating circuit in generating the other than the first cancellation signal is turned off.

34. A circuit according to claim 32 wherein,
the first cancellation signal generating circuit in generating the other than the first cancellation signal provides a second cancellation signal according to an aspect of at least one of the first wireless standard and second wireless standard.

35. A method according to claim 32 wherein,
the first cancellation signal generating circuit in generating the other than the first cancellation signal provides a nulling signal, the nulling signal having at least one of a predetermined time delay, predetermined amplitude relationship, and predetermined phase relationship with respect to the transmit signal.

36. A method according to claim 25 comprising,
a detector circuit, the detector circuit connected to the control signal output port and generating the control signal in dependence upon at least one of measuring the power of the received signal directly and measuring the power of a baseband signal generated from a down-conversion of the received signal.

37. A method according to claim 25 wherein,
providing a transmitter according to the second wireless standard comprises providing a transmitter according to at least one of IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, and IMT-2000.

38. A method according to claim 25 wherein,
providing a receiver according to the first wireless standard comprises providing a receiver according to at least one of IEEE 802.11, IEEE 802.15, IEEE 802.16, IEEE 802.20, UMTS, GSM 850, GSM 900, GSM 1800, GSM 1900, GPRS, Global Navigation Satellite Systems, Global Positioning Systems, Galileo Positioning System, ITU-R 5.138, ITU-R 5.150, and IMT-2000.

39. A method according to claim 25 wherein,
providing the signal to be transmitted comprises providing a signal to be transmitted having a center frequency within a predetermined frequency range of the first wireless standard.

40. A method according to claim 1 wherein,
providing a signal to be transmitted comprises providing a signal to be transmitted having a central frequency outside a predetermined frequency range of the first wireless standard.

41. A method according to claim 40 further comprising,
providing spectral components of the signal to be transmitted within the predetermined frequency range of the first wireless standard.

42. A method according to claim 25 wherein,
providing the first cancellation signal generating circuit comprises providing at least one of a coupler, a power detector, a controller circuit, and a cancellation circuit integrated with at least one of a first circuit forming a portion of a transmitter circuit generating the signal to be transmitted and a second circuit forming part of a receiver circuit for receiving the received signal.

43. A method according to claim 32 wherein,
providing the cancellation circuit comprises providing a first portion of the cancellation circuit integrated with the transmitter and a second portion of the cancellation circuit integrated with the receiver.

44. A method according to claim 42 wherein,
providing at least one of the first circuit and second circuit comprises providing an integrated circuit being manufactured using a semiconductor technology based upon at least one of silicon, silicon-germanium, gallium arsenide, indium phosphide, gallium nitride and polymers.

45. A method according to claim 42 wherein,
providing the cancellation circuit comprises providing at least one of a Cartesian modulator and a polar modulator.

46. A method according to claim 25 wherein,
providing at least one of a predetermined amplitude relationship and predetermined phase relationship is by providing at least one of a Cartesian modulator and a polar modulator.

47. A method according to claim 25 wherein,
combining the first cancellation signal with the received signal comprises providing at least the first cancellation signal and received signal to a low noise amplifier summing circuit forming a portion of a receiver circuit operating according to the first wireless standard.

48. A method according to claim 25 wherein,
providing the first cancellation signal comprises providing the first cancellation signal at least in dependence upon at least an operating characteristic of at least one of the first wireless standard, the second wireless standard, the signal to be transmitted, and the received signal.

49. A method according to claim 48 wherein,
an operating characteristic is at least one of a power, a central frequency, a channel number, dynamic range, sensitivity, and bit error rate.

50. A method according to claim 25 wherein,
the first cancellation signal generating circuit provides at least one of a reduction in the total interfering power from the transmitter within a frequency band according to the first wireless standard and an increase of at least one of sensitivity and dynamic range of the receiver.

51. A method according to claim 25 wherein,
providing the first cancellation signal by other than the transmitter comprises providing the first cancellation signal by at least one of an electrical signal, an optical signal, and a wireless signal.

52. A computer readable medium having stored therein data according to a predetermined computing device format, and upon execution of the data by a suitable computing device a method of improving a receiver is provided, comprising:
providing at least a receiver for receiving signals according to a first wireless standard, the receiver comprising at least one band-limiting filter of a plurality of band-limiting filters;
providing at least a transmitter for transmitting a transmit signal according to a second other wireless standard;
providing a first signal for transmission from the transmitter;
generating a first cancellation signal, the first cancellation signal being at least a portion of the transmit signal and having at least one of a predetermined time delay, predetermined amplitude relationship, and predetermined phase relationship with respect to the transmit signal;
providing the first cancellation signal by other than the transmitter, the first cancellation signal for combining with a received signal received at the receiver;
generating a control signal, the control signal for controlling an aspect of the generation of the first cancellation signal and being generated in dependence upon a measure of the received signal power after the band limiting filters.

53. A computer readable medium according to claim 52 having stored therein data according to a predetermined computing device format, and upon execution of the data by a suitable computing device a method of improving a receiver is provided, comprising:
determining a state of the transmitter;
generating the first cancellation signal according to a first state of the transmitter and generating other than the first cancellation signal in a second state of the transmitter.

54. A computer readable medium having stored therein data according to a predetermined computing device format, and upon execution of the data by a suitable computing device a circuit is provided, comprising:
at least a receiver for receiving signals according to a first wireless standard, the receiver comprising at least one band-limiting filter of a plurality of band-limiting filters;
at least a transmitter for transmitting a transmit signal according to a second other wireless standard;
a first cancellation signal generating circuit for generating a first cancellation signal in response to a control signal, the first cancellation signal being at least a portion of the transmit signal and having at least one of a predetermined time delay, predetermined amplitude relationship, and predetermined phase relationship with respect to the transmit signal;
a transmission path for providing the first cancellation signal by other than the transmitter, the first cancellation signal for combining with a received signal received at the receiver; and
a control signal output port for providing the control signal for controlling an aspect of the generation of the first cancellation signal and being generated in dependence upon a measure of the received signal power after filtering thereof by the band-limiting filters.

55. A computer readable medium according to claim 54 having stored therein data according to a predetermined computing device format, and upon execution of the data by a suitable computing device a circuit is provided, wherein:
the first cancellation signal generating circuit comprises a transmitter enable port for receiving a transmitter enable signal from the transmitter, the transmitter enable signal determining a state of the transmitter, and the first cancellation signal generating circuit generates the first cancellation signal according to a first state of the transmitter and generates other than the first cancellation signal in a second state of the transmitter.
